(19) United States
(12) Patent Application Publication
(10) Pub. No.: US 2008/0233432 A1
(43) Pub. Date: Sep. 25, 2008

(54) Composition, Method for Fabricating Light-Emitting Element, Light-Emitting Element, Light-Emitting Device, and Electronic Device

(75) Inventors: Hideko Inoue, Atsugi (JP); Satoshi Seo, Kawasaki (JP); Satoko Shitagaki, Isehara (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 12/049,480

(22) Filed: Mar. 17, 2008

(30) Foreign Application Priority Data
Mar. 23, 2007 (JP) 2007-077986

(51) Int. Cl. B05D 5/12; B32B 9/00; C07F 15/00; C09K 11/06

(52) U.S. Cl. 428/691; 427/66; 428/690; 544/225; 252/301.16

(57) ABSTRACT

Objects of the present invention are to provide a composition in which an organometallic complex is dissolved and a method for fabricating a light-emitting element using the composition, and to provide a light-emitting element, a light-emitting device, and an electronic device each fabricated using the composition in which the organometallic complex is dissolved. The present invention provides a composition that includes a solvent and an organometallic complex including a ligand having a pyrazine skeleton, bonded to a Group 9 or Group 10 element. A method for fabricating light-emitting elements, which is suitable for industrial application, can be realized by the application of the composition of the present invention to fabrication of a light-emitting element. Furthermore, a light-emitting element with high emission efficiency, a light-emitting device and electronic device with low power consumption can be realized by use of the composition.

### TECHNICAL FIELD

The present invention relates to compositions including organometallic complexes. Further, the present invention relates to light-emitting elements, light-emitting devices, and electronic devices each using electroluminescence and to a method for fabricating light-emitting elements.

### BACKGROUND ART

Organic compounds absorb light, thereby the compounds are converted to an excited state. Through this excited state, various reactions (photochemical reactions) occur in some cases, or luminescence is generated in some cases. Therefore, the organic compounds have been variously applied.

As one example of the photochemical reactions, a reaction of singlet oxygen with an unsaturated organic molecule (oxygen addition) is known (see Nonpatent Document 1: Haruo INOUE and three others, Basic Chemistry Course PHOTOCHEMISTRY I (Maruzen Co., Ltd.), pp. 106-110, for example). Since the ground state of an oxygen molecule is a triplet state, oxygen in a singlet state (singlet oxygen) is not generated by direct photoexcitation. However, singlet oxygen is generated in the presence of any other triplet excited molecule, which leads to an oxygen addition reaction. A compound that can be converted at this time to a triplet excited state is referred to as a photosensitizer.

As described above, generation of singlet oxygen needs a photosensitizer that can be converted to a triplet excited state by photoexcitation. However, it is unlikely that a typical organic compound is converted to a triplet excited molecule because the ground state of the organic compound is typically a singlet state and photoexcitation to a triplet excited state is forbidden transition. For such a photosensitizer, a compound that can easily undergo intersystem crossing from the singlet excited state to the triplet excited state (or a compound that allows forbidden transition in which the compound is directly converted to a triplet excited state by photoexcitation) is thus needed. That is, such a compound can be used as the photosensitizer and regarded as useful.

Furthermore, the above compound often exhibits phosphorescence. Phosphorescence refers to luminescence generated by transition between energies of different multiplicity. In an ordinary organic compound, phosphorescence refers to luminescence that is generated at the time of relax from a triplet excited state to a singlet ground state (in contrast, fluorescence refers to luminescence that is generated at the time of relax from a singlet excited state to a singlet ground state). Application fields of compounds that are capable of exhibiting phosphorescence, in other words, compounds that are capable of converting a triplet excited state into luminescence (hereinafter, referred to as a phosphorescent compound), include a light-emitting element including an organic compound as a light-emitting substance.

This light-emitting element has a simple structure in which a light-emitting layer including an organic compound that is a light-emitting substance is provided between electrodes. This light-emitting element attracts attention as a next-generation flat panel display element in terms of characteristics such as being thin and light in weight, high speed response, and direct current low voltage driving. Further, a display including this light-emitting element is superior in contrast, image quality, and wide viewing angle.

The light-emitting element that includes an organic compound as a light-emitting substance has a mechanism of light emission, which is a carrier injection type: voltage is applied between the electrodes where the light-emitting layer is interposed, electrons and holes injected from the electrodes are recombined to make the light-emitting substance converted to an excited state, and then light is emitted at the time of relax from the excited state to the ground state. As in the case of the photoexcitation described above, types of the excited state include a singlet excited state (S*) and a triplet excited state (T*). The statistical generation ratio thereof in the light-emitting element is considered to be the ratio, S*:T*=1:3.

At room temperature, a compound that is capable of converting a singlet excited state to luminescence (hereinafter, referred to as a fluorescent compound) exhibits only luminescence from the singlet excited state (fluorescence), not luminescence from the triplet excited state (phosphorescence). Accordingly, the internal quantum efficiency (the ratio of generated photons to injected carriers) of the light-emitting element including the fluorescent compound is assumed to have a theoretical limit of 25% based on the ratio, S*:T*=1:3.

On the other hand, in the case of a light-emitting element including the phosphorescent compound described above, the internal quantum efficiency thereof can be improved to 75 to 100% in theory; namely, the emission efficiency thereof can be 3 to 4 times as much as that of the light-emitting element including a fluorescent compound. Therefore, the light-emitting element including a phosphorescent compound has been actively developed in recent years in order to achieve a highly-efficient light-emitting element, (for example, see Nonpatent Document 2: Chihaya ADACHI, and five others, Applied Physics Letters, Vol. 78, No. 11, 2001, pp. 1622-1624). An organometallic complex that contains iridium or the like as a central metal is particularly attracting attention as a phosphorescent compound because of its high phosphorescence quantum yield.

### DISCLOSURE OF INVENTION

An organometallic complex such as the organometallic complex disclosed in Nonpatent Document 2 can be expected to be used as the photosensitizer because of its ease of exhibiting intersystem crossing. Further, application of the organometallic complex to a light-emitting element raises expectations for a highly-efficient light-emitting element because of its ease of exhibiting luminescence (phosphorescence) from a triplet excited state. However, in the present state, the number of kinds of such an organometallic complex is small.

Furthermore, an organometallic complex such as the organometallic complex disclosed in Nonpatent Document 2 is typically deposited by a vacuum evaporation method and used for a light-emitting element. However, the vacuum evaporation method has problems such as low material use efficiency and limitation on substrate size. Therefore, a deposition method other than a vacuum evaporation method has been examined in consideration of productization and mass production of a light-emitting element.

An ink-jet method or a spin coating method has been proposed as a method for depositing an organic compound film on a large-sized substrate. In such deposition, a solution prepared by dissolving an organic compound in a solvent is used.

The above-described organometallic complex, however, has low solubility, and accordingly, it has been impossible to prepare a solution having an concentration enough for the deposition by an ink-jet method or a spin coating method.

Therefore, objects of the present invention are to provide a composition in which an organometallic complex is dissolved and a method for fabricating a light-emitting element using the composition.

Furthermore, objects of the present invention are to provide a light-emitting element, a light-emitting device, and an electronic device each fabricated using the composition in which the organometallic complex is dissolved.

The present inventors have found that an organometallic complex having a pyrazine skeleton has high solubility in a solvent.

Therefore, one aspect of the present invention is a composition that includes a solvent and an organometallic complex including a ligand which has a pyrazine skeleton and is bonded to a Group 9 or Group 10 element.

One aspect of the present invention is a composition that includes a solvent and an organometallic complex having a structure represented by a general formula (G1).

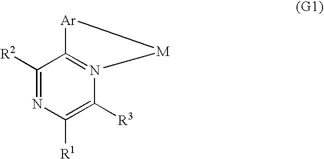

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; and M is a central metal and represents a Group 9 or Group 10 element.

One aspect of the present invention is a composition that includes a solvent and an organometallic complex represented by a general formula (G2).

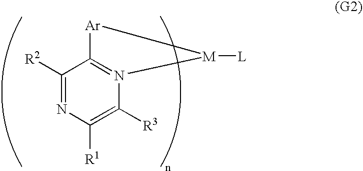

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; M is a central metal and represents a Group 9 or Group 10 element; L is a monoanionic ligand; and n is 2 when M is a Group 9 element and n is 1 when M is a Group 10 element.

In the above structures, R¹ is preferably either an alkyl group or an aryl group in terms of solubility in a solvent.

One aspect of the present invention is a composition that includes a solvent and an organometallic complex having a structure represented by a general formula (G3).

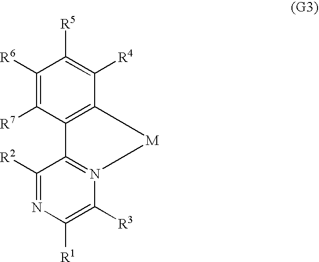

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; and M is a central metal and represents a Group 9 or Group 10 element.

One aspect of the present invention is a composition that includes a solvent and an organometallic complex represented by a general formula (G4).

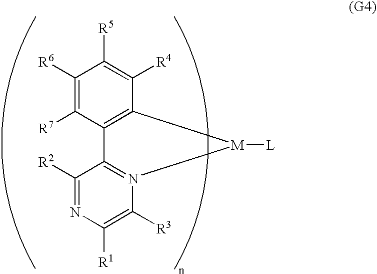

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; M is a central metal and represents a Group 9 or Group 10 element; L is a monoanionic ligand; and n is 2 when M is a Group 9 element and n is 1 when M is a Group 10 element.

In the above structures, it is preferred that L be any one of monoanionic ligands represented by structural formulae (L1) to (L8) given below in terms of solubility in a solvent.

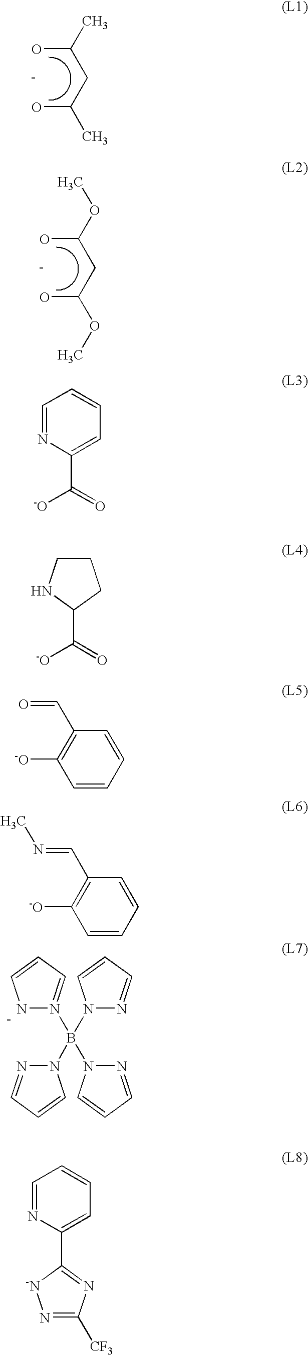

In the above structures, R³ is preferably hydrogen for convenience of synthesis.

In the above structures, M is preferably either iridium or platinum in terms of emission efficiency.

When any of the above compositions is used for fabrication of a light-emitting element, it is preferred that an organometallic complex be dissolved in the solvent at concentrations of 0.6 g/L or more, more preferably 0.9 g/L or more.

In the above structures, any of a variety of solvents can be used as the solvent, and any of the above organometallic complexes can be dissolved in an organic solvent not including an aromatic ring. In particular, the organometallic complex can be dissolved in either ether or alcohol.

When any of the above compositions is used for fabrication of a light-emitting element, it is preferred that the solvent be an organic solvent having a boiling point of from 50° C. to 200° C. inclusive because the solvent needs to be removed for film formation.

In the above structures, the composition may further include an organic semiconductor material.

In the above structures, the composition may further include a binder.

Furthermore, the present invention also covers the light-emitting element fabricated using any of the above compositions. One aspect of the present invention is a light-emitting element that includes, between a pair of electrodes, a layer including an organometallic complex represented by a general formula (G1) and a high molecular compound.

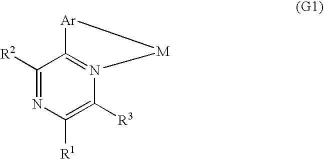

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; and M is a central metal and represents a Group 9 or Group 10 element.

One aspect of the present invention is a light-emitting element that includes, between a pair of electrodes, a layer including an organometallic complex represented by a general formula (G2) and a high molecular compound.

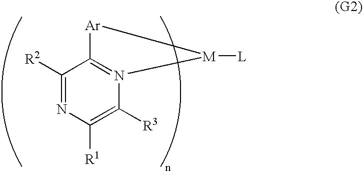

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; M is a central metal and represents a Group 9 or Group 10 element; L is a monoanionic ligand; and n is 2 when M is a Group 9 element and n is 1 when M is a Group 10 element.

In the above structures, R¹ is either an alkyl group or an aryl group.

One aspect of the present invention is a light-emitting element that includes, between a pair of electrodes, a layer including an organometallic complex represented by a general formula (G3) and a high molecular compound.

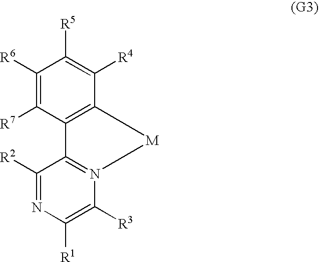

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; and M is a central metal and represents a Group 9 or Group 10 element.

One aspect of the present invention is a light-emitting element that includes, between a pair of electrodes, a layer including an organometallic complex represented by a general formula (G4) and a high molecular compound.

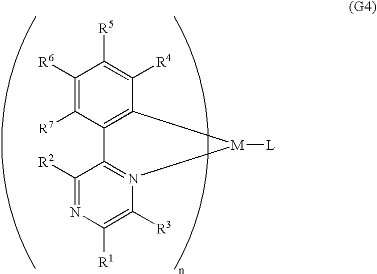

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; M is a central metal and represents a Group 9 or Group 10 element; L is a monoanionic ligand; and n is 2 when M is a Group 9 element and n is 1 when M is a Group 10 element.

In the above structures, it is preferred that L be any one of the monoanionic ligands represented by the structural formulae (L1) to (L8) given below.

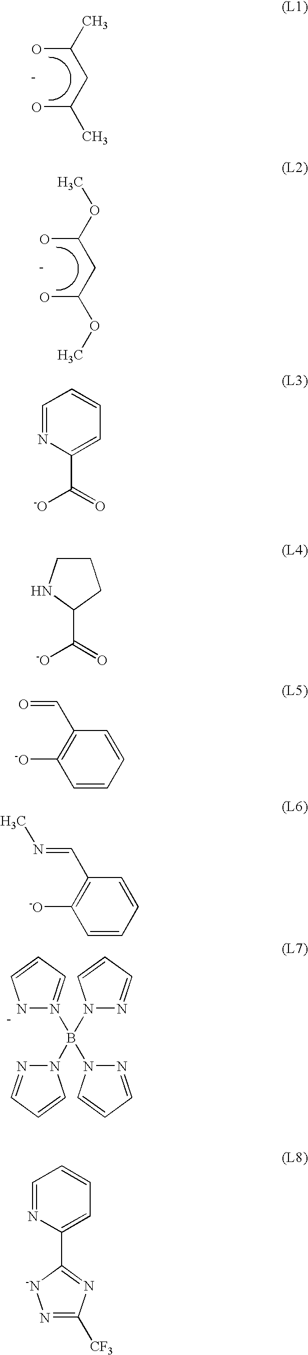

In the above structures, R³ is preferably hydrogen for convenience of synthesis.

In the above structures, M is preferably either iridium or platinum in terms of emission efficiency.

In the above structures, the high molecular compound is an organic semiconductor material.

In the above structures, the high molecular compound is a binder. The layer including the organometallic complex and the high molecular compound further includes an organic semiconductor material.

In the above structures, it is preferred that the layer including the organometallic complex and the high molecular compound be a light-emitting layer.

A hole-transporting layer in contact with the light-emitting layer includes a low molecular compound. An electron-transporting layer in contact with the light-emitting layer includes a low molecular compound.

One aspect of the present invention is a light-emitting device including the above light-emitting element. One aspect of the present invention is a light-emitting device further including a control unit configured to control light emission of the light-emitting element. The category of the light-emitting device in this specification includes image display devices and light sources (e.g., lighting devices). Further, the category of the light-emitting device also includes modules in each of which a connector such as a flexible printed circuit (FPC), a tape automated bonding (TAB) tape, or a tape carrier package (TCP) is attached to a panel; modules in each of which a printed wiring board is provided at an end of a TAB tape or a TCP. Further, the category of the light-emitting device in this specification includes modules in each of which an integrated circuit (IC) is directly mounted on the light-emitting element by a chip on glass (COG) method.

Furthermore, the present invention covers an electronic device in which the light-emitting element of the present invention is used in its display portion. Therefore, one aspect of the present invention is an electronic device that includes a display portion, and the display portion includes the above-described light-emitting element and a control unit configured to control light emission of the light-emitting element.

Furthermore, the present invention covers a method for fabricating a light-emitting element using any of the above compositions. Therefore, one aspect of the present invention is a method for fabricating a light-emitting element, which includes a first step of forming a first electrode, a second step of applying the composition and removing the solvent, and a third step of forming a second electrode.

One aspect of the present invention is a method for fabricating a light-emitting element, which includes the steps of a first step of forming a first electrode, a second step of forming a layer including an organic compound by an evaporation method, a third of applying the composition and removing the solvent, and a forth step of forming a second electrode.

One aspect of the present invention is a method for fabricating a light-emitting element, which includes the steps of: a first step of forming a first electrode, a second step of applying the composition and removing the solvent, a third step of forming a layer including an organic compound by an evaporation method, and a forth step of forming a second electrode.

The compositions of the present invention can be preferably used in fabrication of light-emitting elements because an organometallic complex is dissolved in each composition.

A method for fabricating a light-emitting element, which is suitable for industrial application, can be achieved by use of any of the compositions of the present invention in fabrication of a light-emitting element.

The light-emitting element fabricated using any of the compositions of the present invention can have high emission efficiency.

The light-emitting device and electronic device of the present invention consume less power because they include the light-emitting element having high emission efficiency.

### BRIEF DESCRIPTION OF DRAWINGS

In the accompanying drawings:

FIG. 1 illustrates a light-emitting element of the present invention;

FIG. 2 illustrates a light-emitting element of the present invention;

FIG. 3 illustrates a light-emitting element of the present invention;

FIGS. 4A and 4B illustrate a light-emitting device of the present invention;

FIGS. 5A and 5B illustrate a light-emitting device of the present invention;

FIGS. 6A to 6D illustrate electronic devices of the present invention;

FIG. 7 illustrates an electronic device of the present invention;

FIG. 8 illustrates a lighting device of the present invention;

FIG. 9 illustrates a lighting device of the present invention;

FIG. 10 illustrates current density-luminance characteristics of a light-emitting element of Example 2;

FIG. 11 illustrates voltage-luminance characteristics of a light-emitting element of Example 2;

FIG. 12 illustrates luminance-current efficiency characteristics of a light-emitting element of Example 2;

FIG. 13 illustrates an emission spectrum of a light-emitting element of Example 2;

FIG. 14 illustrates current density-luminance characteristics of a light-emitting element of Example 3;

FIG. 15 illustrates voltage-luminance characteristics of a light-emitting element of Example 3;

FIG. 16 illustrates luminance-current efficiency characteristics of a light-emitting element of Example 3;

FIG. 17 illustrates an emission spectrum of a light-emitting element of Example 3;

FIG. 18 illustrates current density-luminance characteristics of a light-emitting element of Example 4;

FIG. 19 illustrates voltage-luminance characteristics of a light-emitting element of Example 4;

FIG. 20 illustrates luminance-current efficiency characteristics of a light-emitting element of Example 4; and

FIG. 21 illustrates an emission spectrum of a light-emitting element of Example 4.

### BEST MODE FOR CARRYING OUT THE INVENTION

Hereinafter, Embodiment Modes of the present invention are described in detail with reference to the accompanying drawings. It is to be noted that the present invention is not limited to the description below, and modes and details thereof can be modified in various ways without departing from the spirit and the scope of the present invention. Therefore, the present invention should not be interpreted as being limited to the description of the embodiment modes below.

### Embodiment Mode 1

In this embodiment mode, a composition of the present invention is described.

The composition of the present invention includes an organometallic complex having a pyrazine skeleton. The organometallic complex having a pyrazine skeleton has high solubility in a solvent, and thus the concentration can be adjusted to be appropriate for deposition of a layer including the organometallic complex.

It is preferable that, in the organometallic complex having a pyrazine skeleton, a ligand having the pyrazine skeleton be bonded to a Group 9 element (Co, Rh, or Ir) or a Group 10 element (Ni, Pd, or Pt). In other words, it is preferable that a central metal be a Group 9 or Group 10 element. The bonding of the ligand having the pyrazine skeleton to a Group 9 or Group 10 element can achieve high emission efficiency.

Various organometallic complexes can be given as examples of the organometallic complex having a pyrazine skeleton. When the ligand is a 2-arylpyrazine derivative, the ligand can undergo cyclometallation with the central metal. Furthermore, a cyclometallated complex can have high phosphorescence quantum yield. Therefore, it is preferable that the ligand be a 2-arylpyrazine derivative. Accordingly, use of an organometallic complex having the structure represented by the general formula (G1) is preferable.

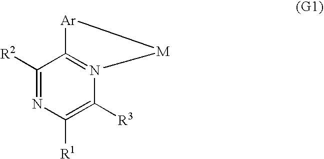

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; and M is a central metal and represents a Group 9 or Group 10 element.

Furthermore, it is preferred that the organometallic complex having the structure represented by the general formula (G1) be a mixed ligand organometallic complex also including a ligand L other than the pyrazine derivative. This is because the synthesis is made simpler. Also in terms of solubility in a solvent, an organometallic complex including a monoanionic ligand L is preferable. Accordingly, use of an organometallic complex represented by the general formula (G2) is preferable.

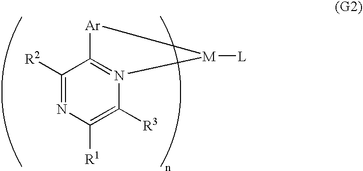

In the formula, Ar represents an arylene group; R¹ represents any one of hydrogen, an alkyl group, and an aryl group; R² represents either an alkyl group or an aryl group; R³ represents any one of hydrogen, an alkyl group, and an aryl group; M is a central metal and represents a Group 9 or Group 10 element; L is a monoanionic ligand; and n is 2 when M is a Group 9 element and n is 1 when M is a Group 10 element.

The present inventors have found that, particularly when R¹ is either an alkyl group or an aryl group, the organometallic complex having the structure represented by the general formula (G1) and the organometallic complex represented by the general formula (G2) have high solubility in the solvent. Therefore, it is preferable that R¹ be either an alkyl group or an aryl group in each of the organometallic complex having the structure represented by the general formula (G1) and the organometallic complex represented by the general formula (G2).

Furthermore, when the ligand is a 2-phenylpyrazine derivative which is a type of a 2-arylpyrazine derivative, the ligand can undergo orthometallation with the central metal (orthometallation is a type of cyclometallation). The present inventors have found that an orthometalated complex formed by orthometallation of 2-phenylpyrazine can have high phosphorescence quantum yield. Therefore, an organometallic complex including a 2-phenylpyrazine derivative as the ligand is preferable. Accordingly, use of an organometallic complex having the structure represented by the general formula (G3) is preferable.

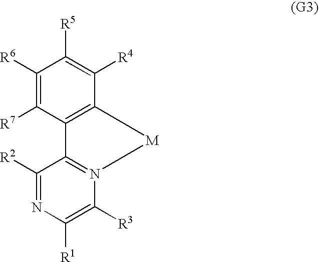

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; and M is a central metal and represents a Group 9 or Group 10 element.

Furthermore, it is preferred that the organometallic complex having the structure represented by the general formula (G3) be a mixed ligand organometallic complex also including a ligand L other than a pyrazine derivative. This is because the synthesis is made simpler. Also in terms of solubility in a solvent, use of an organometallic complex having the monoanionic ligand L is preferable. Accordingly, use of an organometallic complex represented by the general formula (G4) is preferable.

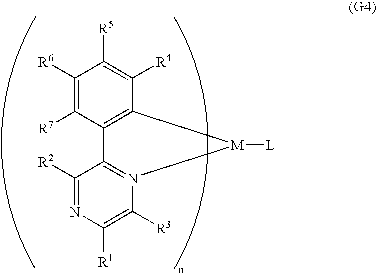

In the formula, Ar represents an arylene group; R¹ represents either an alkyl group or an aryl group; R² represents either an alkyl group or an aryl group; R³ represents any one of hydrogen, an alkyl group, and an aryl group; R⁴ to R⁷ each represent any one of an alkyl group, a halogen, and a haloalkyl group; M is a central metal and represents a Group 9 or Group 10 element; L is a monoanionic ligand; and n is 2 when M is a Group 9 element and n is 1 when M is a Group 10 element.

Specific examples of the arylene group Ar include a substituted or unsubstituted 1,2-phenylene group, a 1,2-naphthylene group, a 2,3-naphthylene group, a spirofluorene-2,3-diyl group, a 9,9-dialkylfluorene-yl group such as a 9,9-dimethylfluorene-2,3-diyl group, and the like. In particular, it is advantageous that the arylene group Ar is a substituted or unsubstituted 1,2-phenylene group when the organometallic complex is vaporized for the purpose of sublimation purification or the like, because the rise of the vaporizing temperature caused by the increase of molecular weight can be suppressed. In the case where the 1,2-phenylene group has a substituent, specific examples of the substituent include an alkyl group such as a methyl group, an ethyl group, an isopropyl group, or a tert-butyl group; an alkoxy group such as a methoxy group, an ethoxy group, an isopropoxy group, or a tert-butoxy group; an aryl group such as a phenyl group or a 4-biphenylyl group; a halogen group such as a fluoro group; and a trifluoromethyl group. Use of an unsubstituted 1,2-phenylene group is particularly preferable among the specific examples of the arylene group Ar.

In the above structures, a methyl group, an ethyl group, an isopropyl group, a tert-butyl group, a cyclohexyl group, a pentyl group, or the like can be used as the alkyl group. It is to be noted that use of an alkyl group having 5 or more carbon atoms is preferable in the above-described organometallic complexes in terms of solubility in a solvent. However, the organometallic complexes each have a feature of having high solubility even in the case where an alkyl group having 4 or less carbon atoms is used as the alkyl group. That is, the composition of the present invention is characterized in that the alkyl group is an alkyl group having 4 or less carbon atoms, such as a methyl group, an ethyl group, an isopropyl group, or a tert-butyl group, in the above-described organometallic complexes.

In the above structures, a fluoro group, a chloro group, or the like can be used as the halogen group, and use of the fluoro group is preferable in terms of chemical stability. Furthermore, use of a trifluoromethyl group is preferable as the haloalkyl group.

In the above structures, as the aryl group, a substituted or unsubstituted phenyl group, a 1-naphthyl group, a 2-naphthyl group, a spirofluorene-2-yl group, a 9,9-dialkylfluorene-yl group such as a 9,9-dimethylfluorene-2-yl group, or the like can be used. Use of an aryl group having 6 to 25 carbon atoms is preferable in consideration of solubility in the solvent. In the case where the above aryl group has a substituent, specific examples of the substituent include an alkyl group such as a methyl group, an ethyl group, an isopropyl group, or a tert-butyl group; an alkoxy group such as a methoxy group, an ethoxy group, an isopropoxy group, or a tert-butoxy group; an aryl group such as a phenyl group or 4-biphenylyl group; a halogen group such as a fluoro group; and a trifluoromethyl group.

It is preferable that the monoanionic ligand L in the general formulae (G2) and (G4) be any one of a monoanionic bidentate chelate ligand having a β-diketone structure, a monoanionic bidentate chelate ligand having a carboxyl group, a monoanionic bidentate chelate ligand having a phenolic hydroxyl group, and a monoanionic bidentate chelate ligand in which two ligand elements are both nitrogen, because of their high coordinating ability and also solubility in the solvent.

More specifically, the monoanionic ligands represented by the structural formulae (L1) to (L8) are given below as nonlimiting examples.

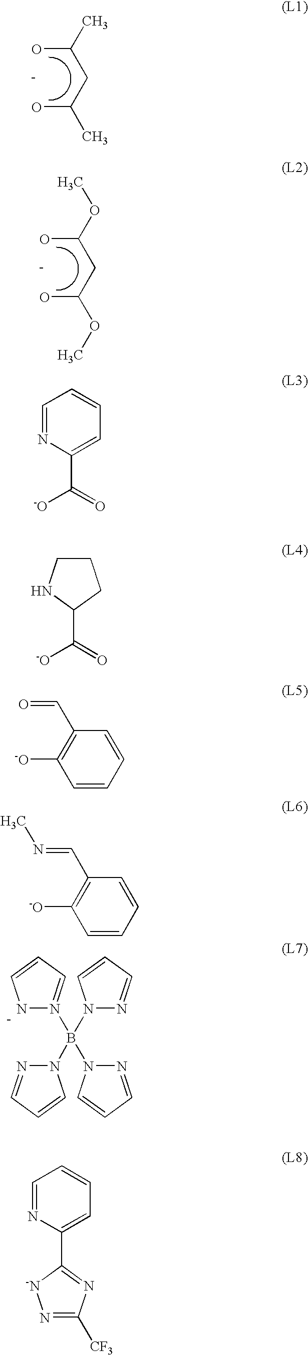

In the general formulae (G1) to (G4), it is preferred that R³ be hydrogen for convenience of synthesis. It is preferable that R³ be hydrogen in terms of synthetic yield because steric hindrance of the ligand is reduced.

Furthermore, it is preferred that the central metal M of each organometallic complex described above be either iridium or platinum in terms of heavy atom effect. Use of iridium is particularly preferable because of high efficiency by remarkable heavy atom effect and chemical stability.

Specifically, organometallic complexes represented by structural formulae (1) to (49) given below are given as nonlimiting examples of the above-described organometallic complexes.

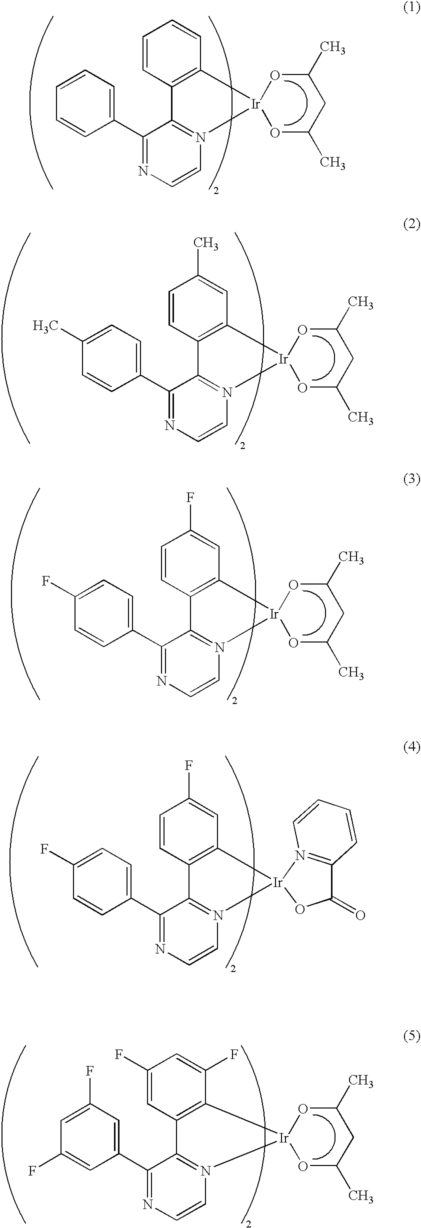

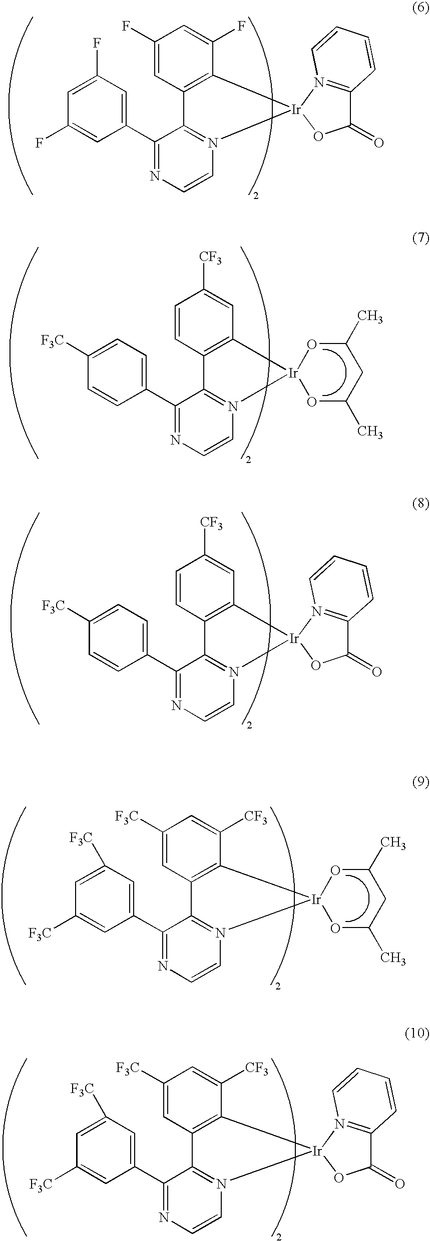

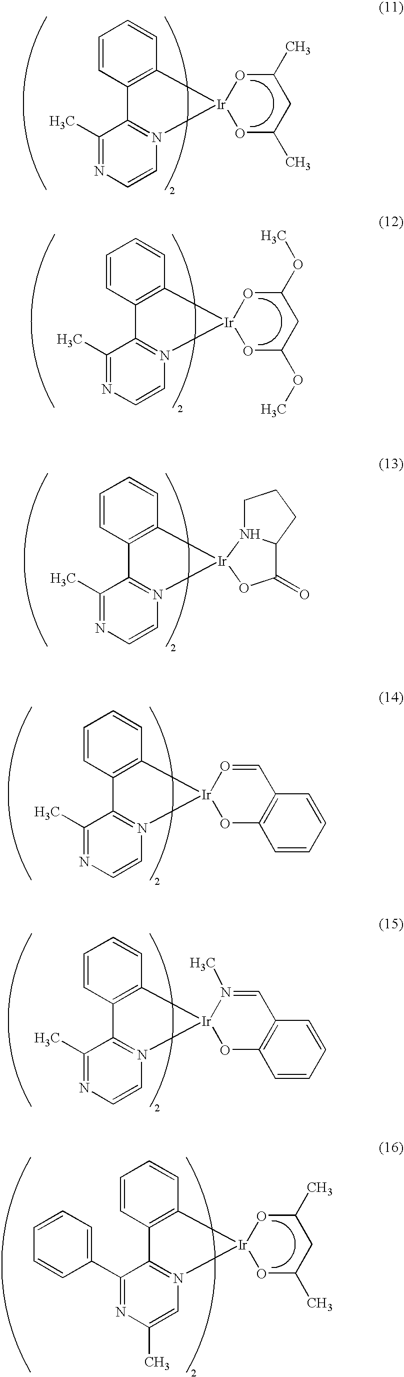

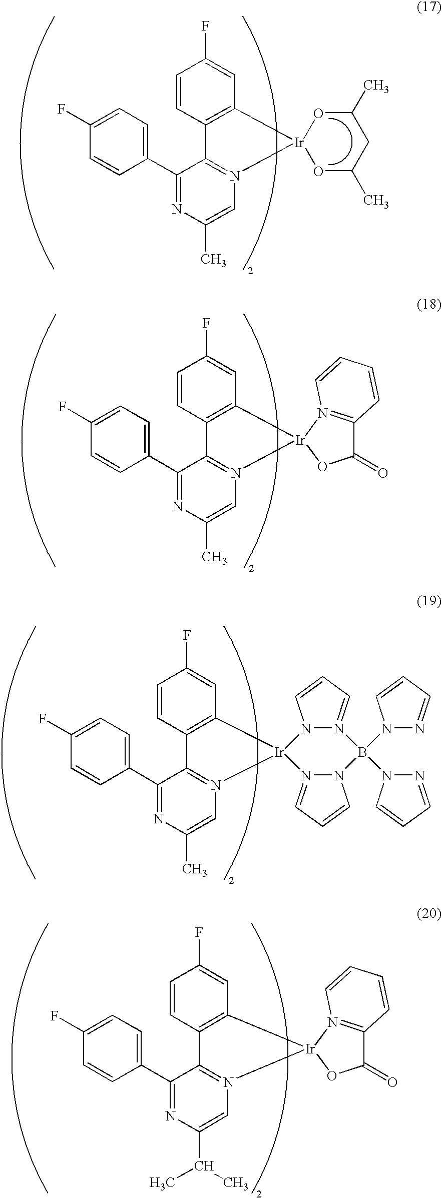

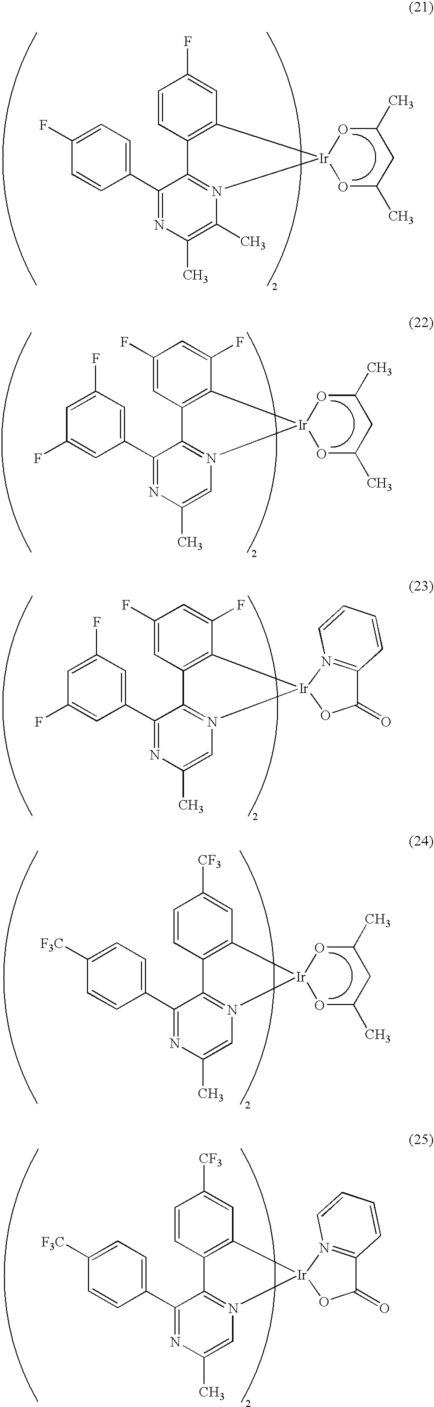

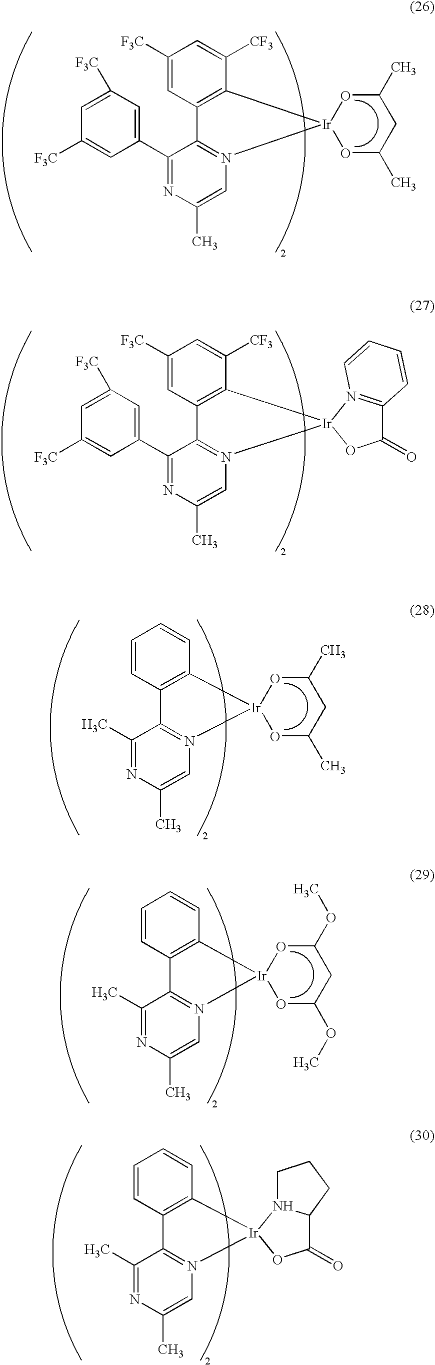

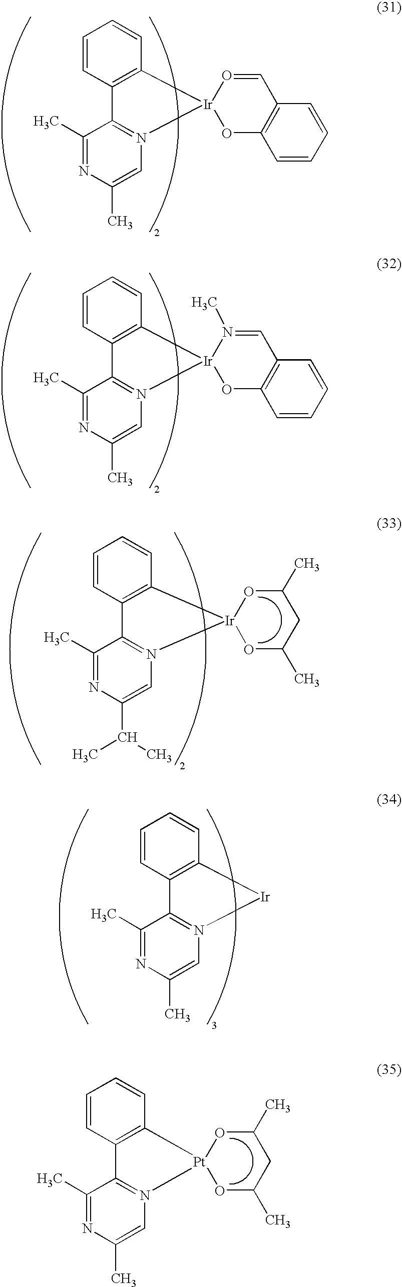

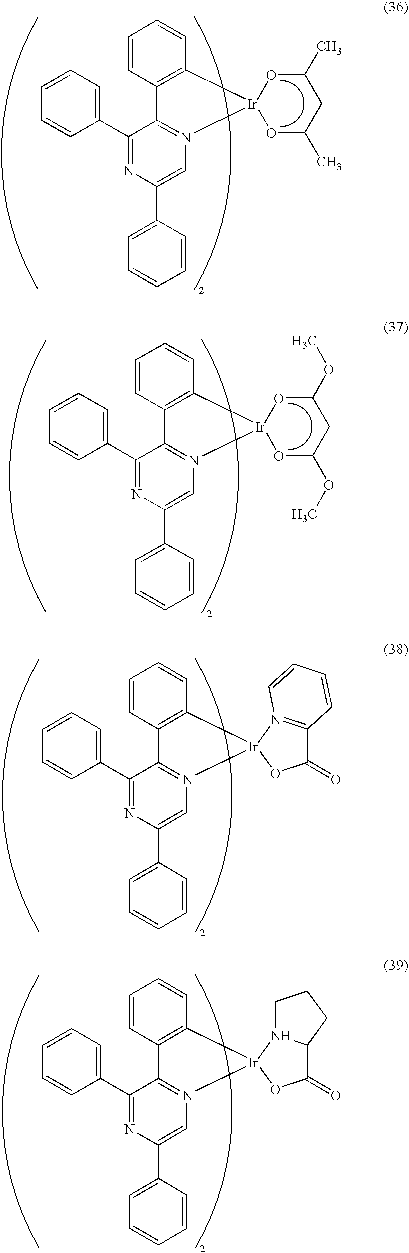

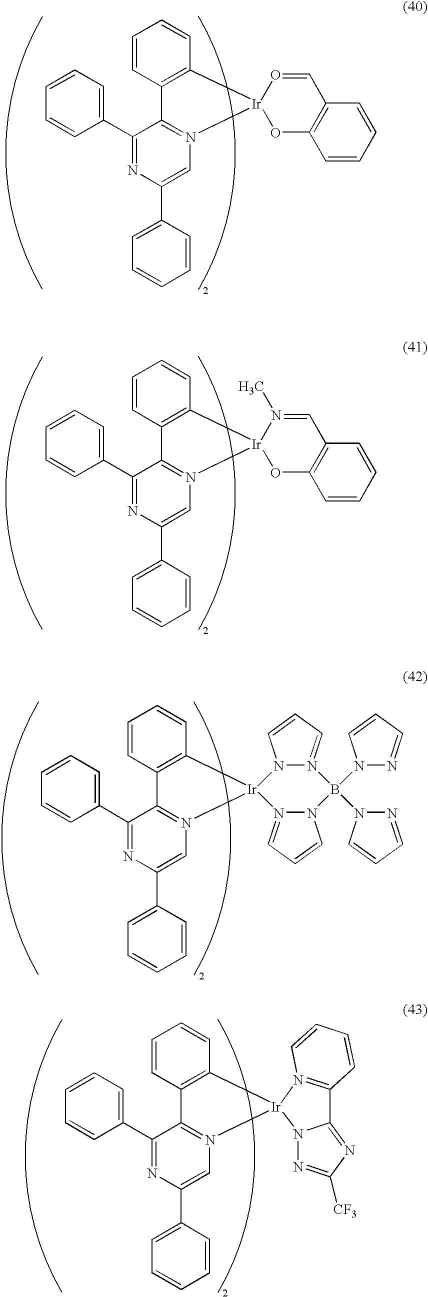

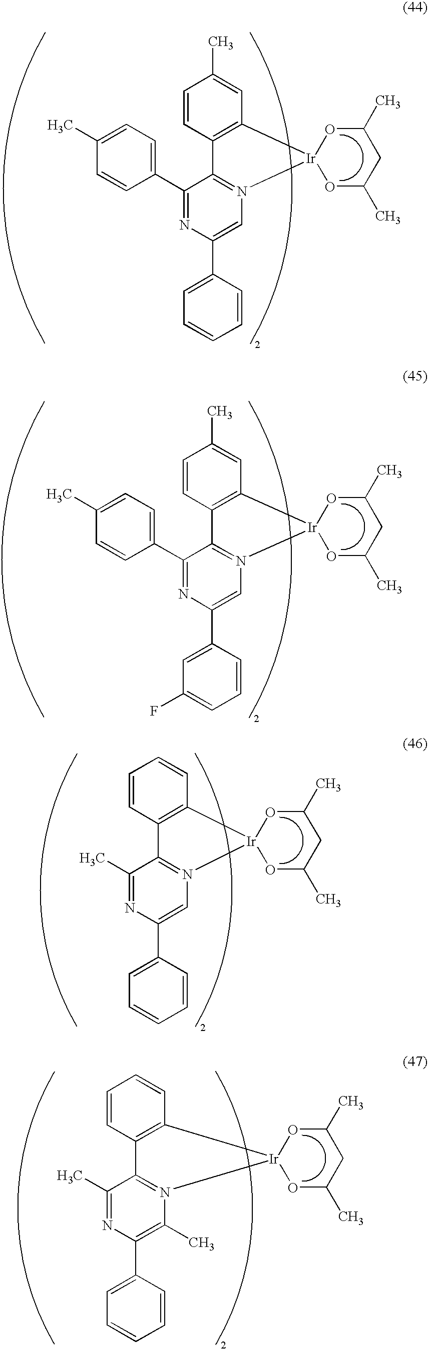

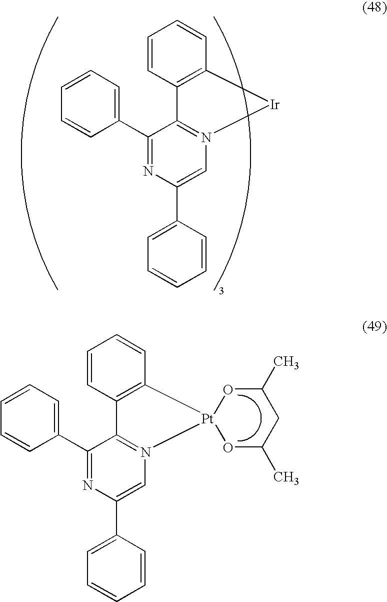

In the composition of the present invention, any of the above-described organometallic complexes can be dissolved in a variety of solvents. For example, the organometallic complex can be dissolved in a solvent having an aromatic ring (e.g., a benzene ring), such as toluene or methoxybenzene (anisole). Furthermore, each organometallic complex described above can be dissolved in an organic solvent not having an aromatic ring, such as dimethylsulfoxide (DMSO), dimethylformamide (DMF), or chloroform.

Furthermore, each of the above-described organometallic complexes can also be dissolved in ether such as diethyl ether or dioxane, or alcohol such as methanol, ethanol, isopropanol, butanol, 2-methoxyethanol, or 2-ethoxyethanol. Use of a composition that uses alcohol as a solvent is highly effective because layers can be stacked to form an EL layer by use of such a composition. That is, after a layer including an organic compound is formed by an evaporation method or the like, a layer can be further formed thereon by use of the composition that uses alcohol as a solvent.

When the composition is used in film formation in fabrication of a light-emitting element, it is preferred that the organometallic complex be dissolved in the solvent at concentrations of 0.6 g/L or more, more preferably 0.9 g/L or more.

When the composition is used in film formation in fabrication of a light-emitting element or the like, it is preferred that the solvent be an organic solvent having a boiling point of from 50° C. to 200° C. inclusive because the solvent needs to be removed for film formation.

Furthermore, when the composition described in this embodiment mode is used in fabrication of a light-emitting element, it is preferred that the composition further include an organic semiconductor material. For the organic semiconductor material, an aromatic compound or heteroaromatic compound which is solid at room temperature can be used. Although a low molecular compound or a high molecular compound can be used for the organic semiconductor material, use of a high molecular compound is particularly preferable in terms of quality of the formed films. When a low molecular compound is used, a low molecular compound (also referred to as a medium molecular compound) having a substituent that is capable of increasing the solubility in a solvent is preferably used.

The composition may further include a binder in order to improve quality of the formed films. For the binder, use of a high molecular compound that is electrically inactive is preferable. Specifically, polymethylmethacrylate (PMMA), polyimide, or the like can be used.

The organometallic complex is dissolved in the composition described in this embodiment mode, and use of the composition is preferable in fabrication of a light-emitting element. Specifically, the organometallic complex is dissolved at a concentration enough for the deposition of a film including an organic compound, and thus use of the composition is preferable in fabrication of a light-emitting element.

Furthermore, the composition described in this embodiment mode includes the organometallic complex having a pyrazine skeleton, which is capable of light emission with high emission efficiency. Thus, the composition is suitable for fabrication of a light-emitting element having excellent characteristics.

Layers can be stacked to form an EL layer of a light-emitting element by application of the composition which uses alcohol as a solvent to fabrication of the light-emitting element. That is, after a layer including an organic compound is formed by an evaporation method or the like, a layer can be further formed thereon using the composition which uses alcohol as a solvent. Thus, a light-emitting element having excellent characteristics can be fabricated.

### Embodiment Mode 2

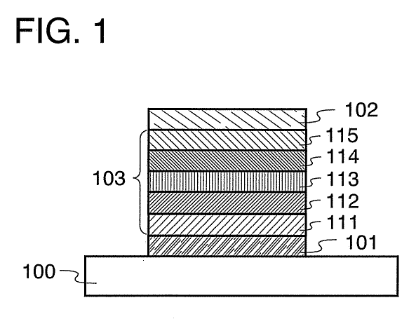

One mode of a light-emitting element using the composition of the present invention and a method for fabricating the light-emitting element is described below using FIG. 1.

It is to be noted that, in this specification, being composite refers not only to a state in which two materials are simply mixed but also a state in which two materials are mixed and charges are transferred between the materials.

The light-emitting element of the present invention has a plurality of layers between a pair of electrodes. The plurality of layers are a combination of layers formed of a substance having a high carrier-injecting property and a substance having a high carrier-transporting property which are stacked so that a light-emitting region is formed in a region away from the electrodes, that is, so that recombination of carriers is performed in an area away from the electrodes.

In FIG. 1, a substrate 100 is used as a base of the light-emitting element. For the substrate 100, glass, plastic, or the like may be used, for example. Any material other than those may be used as long as the material functions as a base of the light-emitting element.

In this embodiment mode, a light-emitting element includes a first electrode 101, a second electrode 102, and an EL layer 103 provided between the first electrode 101 and the second electrode 102. In this embodiment mode, it is assumed that the first electrode 101 functions as an anode and the second electrode 102 functions as a cathode. In other words, in the description below, it is assumed that light emission is obtained when voltage is applied to the first electrode 101 and the second electrode 102 so that the potential of the first electrode 101 becomes higher than that of the second electrode 102.

It is preferred that the first electrode 101 be formed using a metal, an alloy, or a conductive compound each having a high work function (specifically, 4.0 eV or higher), a mixture thereof, or the like. Specifically, indium tin oxide (ITO), ITO containing silicon or silicon oxide, indium zinc oxide (IZO), indium oxide containing tungsten oxide and zinc oxide (IWZO), or the like can be used. Such conductive metal oxide are typically deposited by a sputtering method, but may also be deposited by application of a sol-gel process or the like. For example, indium zinc oxide (IZO) can be deposited by a sputtering method using a target in which 1 to 20 wt % of zinc oxide is added to indium oxide. Indium oxide containing tungsten oxide and zinc oxide (IWZO) can be deposited by a sputtering method using a target in which 0.5 to 5 wt % of tungsten oxide and 0.1 to 1 wt % of zinc oxide are added to indium oxide. Further, gold (Au), platinum (Pt), nickel (Ni), tungsten (W), chromium (Cr), molybdenum (Mo), iron (Fe), cobalt (Co), copper (Cu), palladium (Pd), nitride of a metal material (e.g., titanium nitride), or the like can be used as the material for the first electrode 101.

When a layer including a composite material which is described later is used as a layer having a contact with the first electrode 101, the first electrode 101 can be formed using any of a variety of metals, an alloy, a conductive compound, a mixture of them, or the like regardless of their work functions. For example, aluminum (Al), silver (Ag), an aluminum alloy (AlSi), or the like can be used. Alternatively, any of the following low-work function materials can be used: Group 1 and Group 2 elements of the periodic table, that is, alkali metals such as lithium (Li) and cesium (Cs) and alkaline-earth metals such as magnesium (Mg), calcium (Ca), and strontium (Sr), and alloys thereof (MgAg, AlLi); rare earth metals such as europium (Eu) and ytterbium (Yb), and alloys thereof; and the like. Films including an alkali metal, an alkaline earth metal, or an alloy thereof can be formed by a vacuum evaporation method. Alternatively, films including an alloy of an alkali metal or an alkaline earth metal can be formed by a sputtering method. Further alternatively, a film can be formed using a silver paste by an ink-jet method.

There is no particular limitation on a stacked structure of an EL layer 103. It is acceptable as long as the EL layer 103 is formed by any combination of the light-emitting layer described in this embodiment mode, with layers each containing a substance having a high electron-transporting property, a substance having a high hole-transporting property, a substance having a high electron-injecting property, a substance having a high hole-injecting property, a bipolar substance (a substance having a high electron-transporting and hole-transporting property), or the like. For example, any combination of a hole-injecting layer, a hole-transporting layer, a light-emitting layer, an electron-transporting layer, an electron-injecting layer, and the like can be employed. Materials for each layer are exemplified below.

A hole-injecting layer 111 is a layer including a substance having a high hole-injecting property. As a substance having a high hole-injecting property, molybdenum oxide, vanadium oxide, ruthenium oxide, tungsten oxide, manganese oxide, or the like can be used. Alternatively, the hole-injecting layer 111 can be formed using any one of the following materials: phthalocyanine compounds such as phthalocyanine (H₂Pc) and copper phthalocyanine (CuPc), high molecular compounds such as poly(3,4-ethylenedioxythiophene)/poly(styrenesulfonic acid) (PEDOT/PSS), and the like.

Alternatively, the hole-injecting layer 111 can be formed using a composite material in which an acceptor substance is mixed into a substance having a high hole-transporting property. It is to be noted that a material for forming the electrode can be selected regardless of its work function by use of the composite material in which an acceptor substance is mixed into a substance having a high hole-transporting property. That is, not only a high-work function material, but also a low-work function material can be used for the first electrode 101. Examples of the acceptor substance include 7,7,8,8-tetracyano-2,3,5,6-tetrafluoroquinodimethane (F₄-TCNQ), chloranil, transition metal oxide, and oxide of metals that belong to Group 4 to Group 8 of the periodic table. Specifically, any of vanadium oxide, niobium oxide, tantalum oxide, chromium oxide, molybdenum oxide, tungsten oxide, manganese oxide, and rhenium oxide is preferably used because of their high electron accepting property. In particular, use of molybdenum oxide is more preferable because of its stability in the atmosphere, low hygroscopic property, and easiness of handling.

As the substance having a high hole-transporting property used for the composite material, any of a variety of compounds such as an aromatic amine compound, a carbazole derivative, aromatic hydrocarbon, or a high molecular weight compound (e.g., an oligomer, a dendrimer, or a polymer) can be used. A substance having a hole mobility of 10⁻⁶ cm²/Vs or more is preferably used as substance having a high hole-transporting property used for the composite material. It is to be noted that any substance other than the above substances may also be used as long as it is a substance in which the hole-transporting property is higher than the electron-transporting property. Organic compounds that can be used for the composite material are specifically shown below.

Examples of the aromatic amine compound that can be used for the composite material include N;N′-di(p-tolyl)-N,N′-diphenyl-p-phenylenediamine (DTDPPA), 4,4′-bis[N-(4-diphenylaminophenyl)-N-phenylamino]biphenyl (DPAB), 4,4′-bis(N-{4-[N′-(3-methylphenyl)-N′-phenylamino]phenyl}-N-phenylamino)biphenyl (DNTPD), 1,3,5-tris[N-(4-diphenylaminophenyl)-N-phenylamino]benzene (DPA3B), and the like.

Examples of the carbazole derivatives which can be used for the composite material include 3-[N-(9-phenylcarbazol-3-yl)-N-phenylamino]-9-phenylcarbazole (PCzPCA1), 3,6-bis[N-(9-phenylcarbazol-3-yl)-N-phenylamino]-9-phenylcarbazole (PCzPCA2), 3-[N-(1-naphtyl)-N-(9-phenylcarbazol-3-yl)amino]-9-phenylcarbazole (PCzPCN1), and the like.

Examples of the carbazole derivatives which can be used for the composite material further include 4,4′-di(N-carbazolyl)biphenyl (CBP), 1,3,5-tris[4-(N-carbazolyl)phenyl]benzene (TCPB), 9-[4-(N-carbazolyl)]phenyl-10-phenylanthracene (CzPA), 1,4-bis[4-(N-carbazolyl)phenyl]-2,3,5,6-tetraphenylbenzene, and the like.

Examples of the aromatic hydrocarbon which can be used for the composite material include 2-tert-butyl-9,10-di(2-naphthyl)anthracene (t-BuDNA), 2-tert-butyl-9,10-di(1-naphthyl)anthracene, 9,10-bis(3,5-diphenylphenyl)anthracene (DPPA), 2-tert-butyl-9,10-bis(4-phenylphenyl)anthracene (t-BuDBA), 9,10-di(2-naphthyl)anthracene (DNA), 9,10-diphenylanthracene (DPAnth), 2-tert-butylanthracene (t-BuAnth), 9,10-bis(4-methyl-1-naphthyl)anthracene (DMNA), 9,10-bis[2-(1-naphthyl)phenyl]-2-tert-butyl-anthracene; 9,10-bis[2-(1-naphthyl)phenyl]anthracene, 2,3,6,7-tetramethyl-9,10-di(1-naphthyl)anthracene, 2,3,6,7-tetramethyl-9,10-di(2-naphthyl)anthracene, 9,9′-bianthryl, 10,10′-diphenyl-9,9′-bianthryl, 10,10′-bis(2-phenylphenyl)-9,9′-bianthryl, 10,10′-bis[(2,3,4,5,6-pentaphenyl)phenyl]-9,9′-bianthryl, anthracene, tetracene, rubrene, perylene, 2,5,8,11-tetra(tert-butyl)perylene, and the like. Besides these compounds, pentacene, coronene, or the like can also be used. As described above, use of an aromatic hydrocarbon which has a hole mobility of 1×10⁻⁶ cm²/Vs or more and has 14 to 42 carbon atoms is more preferable.

The aromatic hydrocarbon which can be used for the composite material may have a vinyl skeleton. Examples of the aromatic hydrocarbon having a vinyl skeleton include 4,4′-bis(2,2-diphenylvinyl)biphenyl (DPVBi) 9,10-bis[4-(2,2-diphenylvinyl)phenyl]anthracene (DPVPA), and the like.

For the hole-injecting layer 111, a high molecular compound (e.g., an oligomer, a dendrimer, or a polymer) can be used. Specifically, a high molecular compound such as poly(N-vinylcarbazole) (PVK), poly(4-vinyltriphenylamine) (PVTPA), poly[N-(4-{N ′-[4-(4-diphenylamino)phenyl]phenyl-N′-phenylamino}phenyl)methacrylamide] (PTPDMA), or poly[N,N′-bis(4-butylphenyl)-N,N′-bis(phenyl)benzidine] (Poly-TPD) can be used. Alternatively, a high molecular compound mixed with acid, such as poly(3,4-ethylenedioxythiophene)/poly(styrenesulfonic acid) (PEDOT/PSS) or polyaniline/poly(styrenesulfonic acid) (PAni/PSS) can also be used.

It is to be noted that the hole-injecting layer 111 can be formed using a composite material of the above-described high molecular compound, such as PVK, PVTPA, PTPDMA, or Poly-TPD, and the above-described acceptor substance.

A hole-transporting layer 112 is a layer including a substance having a high hole-transporting property. Examples of the substance having a high hole-transporting property include aromatic amine compounds such as 4,4′-bis[N-(1-naphthyl)-N-phenylamino]biphenyl (NPB or α-NPB), N,A′-bis(3-methylphenyl)-N,N′-diphenyl-[1,1′-biphenyl]-4,4′-diamine (TPD), 4,4′,4″-tris(N,N-diphenylamino)triphenylamine (TDATA), 4,4′,4″-tris[N-(3-methylphenyl)-N-phenylamino]triphenylamine (MTDATA), and 4,4′-bis[N-(spiro-9,9′-bifluoren-2-yl)-N-phenylamino]-1,1′-biphenyl (BSPB). These substances described here are mainly substances each having a hole mobility of 10⁻⁶ cm²/Vs or more. Any substance other than the above substances may also be used as long as it is a substance in which the hole-transporting property is higher than the electron-transporting property. The layer including a substance having a high hole-transporting property is not limited to a single layer, and may be a stack of two or more layers each including the aforementioned substance.

For the hole-transporting layer 112, a high molecular compound such as PVK, PVTPA, PTPDMA, or Poly-TPD can be used alternatively.

A light-emitting layer 113 is a layer including a substance having a high light-emitting property. The light-emitting layer 113 can be formed using the composition described in Embodiment Mode 1. Specifically, the composition described in Embodiment Mode 1 may be applied by an ink-jet method, a spin coating method, or the like, and then the solvent may be removed. For removing the solvent, a heat treatment, a low pressure treatment, a heat treatment under low pressure, or the like is employed.

At this time, it is preferable that the solvent included in the composition be alcohol for the following reason. Low molecular compounds as used for light-emitting elements typically are characterized in that it is difficult to solve such low molecular compounds for the light-emitting element in alcohol. Therefore, when the solvent included in the composition is alcohol, even if a layer including a low molecular compound formed by an evaporation method or the like has been formed before the formation of a light-emitting layer, the light-emitting layer can be stacked thereon by application of the composition by a wet process.

An electron-transporting layer 114 is a layer including a substance having a high electron-transporting property. For example, it is possible to employ a layer made of a metal complex or the like having a quinoline or benzoquinoline skeleton, such as tris(8-quinolinolato)aluminum (Alq), tris(4-methyl-8-quinolinolato)aluminum (Almq₃), bis(10-hydroxybenzo[h]quinolinato)beryllium (BeBq₂), or bis(2-methyl-8-quinolinolato)(4-phenylphenolato)aluminum (BAlq). Alternatively, a metal complex or the like having an oxazole-based or thiazole-based ligand, such as bis[2-(2-hydroxyphenyl)benzoxazolato]zinc (Zn(BOX)₂) or bis[2-(2-hydroxyphenyl)benzothiazolato]zinc (Zn(BTZ)₂) can be used. Instead of the metal complex, 2-(4-biphenylyl)-5-(4-tert-butylphenyl)-1,3,4-oxadiazole (PBD), 1,3-bis[5-(p-tert-butylphenyl)-1,3,4-oxadiazol-2-yl]benzene (OXD-7), 3-(4-biphenylyl)-4-phenyl-5-(4-tert-butylphenyl)-1,2,4-triazole (TAZ), bathophenanthroline (BPhen), bathocuproine (BCP), or the like can also be used. The substances described here are mainly substances each having an electron mobility of greater than or equal to 10⁻⁶ cm²/Vs. Any substance other than the above substances may also be used as long as it is a substance in which the electron-transporting property is higher than the hole-transporting property. Furthermore, the electron-transporting layer is not limited to a single layer, and may be a stack of two or more layers each including the aforementioned substance.

For the electron-transporting layer 114, a high molecular compound such as poly[(9,9-dihexylfluorene-2,7-diyl)-co-(pyridine-3,5-diyl)](PF-Py) or poly[(9,9-dioctylfluorene-2,7-diyl)-co-(2,2′-bipyridine-6,6′-diyl)](PF-BPy) can be used.

An electron-injecting layer 115 may be provided. The electron-injecting layer 115 can be formed using an alkali metal compound or an alkaline earth metal compound such as lithium fluoride (LiF), cesium fluoride (CsF), or calcium fluoride (CaF₂). Furthermore, a layer, in which a substance having an electron-transporting property is combined with an alkali metal or an alkaline earth metal, can be employed. For example, it is possible to use a layer made of Alq in which magnesium (Mg) is included. It is more preferable to use the layer in which a substance having an electron-transporting property is combined with an alkali metal or an alkaline earth metal as the electron-injecting layer, since electron injection from the second electrode 102 efficiently proceeds.

The second electrode 102 can be formed using a metal, an alloy, or a conductive compound each having a low work function (specifically, 3.8 eV or lower), a mixture of them, or the like. Specific examples of such cathode materials include elements belonging to Group 1 and 2 of the periodic table, i.e., alkali metals such as lithium (Li) and cesium (Cs) and alkaline earth metals such as magnesium (Mg), calcium (Ca), and strontium (Sr); alloys of them (e.g., MgAg and AlLi); rare earth metals such as europium (Eu) and ytterbium (Yb), alloys of them; and the like. Films including an alkali metal, an alkaline earth metal, or an alloy thereof can be formed by a vacuum evaporation method. Alternatively, films including an alkali metal, an alkaline earth metal, or an alloy thereof can be formed by a sputtering method. Further alternatively, a film can be formed using a silver paste by an ink-jet method or the like.

When the electron-injecting layer 115 is provided between the second electrode 102 and the electron-transporting layer 114, any of a variety of conductive materials such as Al, Ag, ITO, or ITO containing silicon or silicon oxide can be used for the second electrode 102 regardless of its work function. These conductive materials can be deposited by a sputtering method, an ink-jet method, a spin coating method, or the like.

In the light-emitting element having the above structure, which is described in this embodiment mode, application of voltage between the first electrode 101 and the second electrode 102 makes current flow, whereby holes and electrons are recombined in the light-emitting layer 113 that is a layer including a substance having a high light-emitting property, and light is emitted. That is, a light-emitting region is formed in the light-emitting layer 113.

Light is extracted outside through one or both of the first electrode 101 and the second electrode 102. Therefore, one or both of the first electrode 101 and the second electrode 102 are light-transmissive electrodes. When only the first electrode 101 is a light-transmissive electrode, light is extracted from the substrate side through the first electrode 101. In contrast, when only the second electrode 102 is a light-transmissive electrode, light is extracted from a side opposite to the substrate side through the second electrode 102. When both of the first electrode 101 and the second electrode 102 are light-transmissive electrodes, light is extracted from both the substrate side and the side opposite to the substrate side through the first electrode 101 and the second electrode 102.

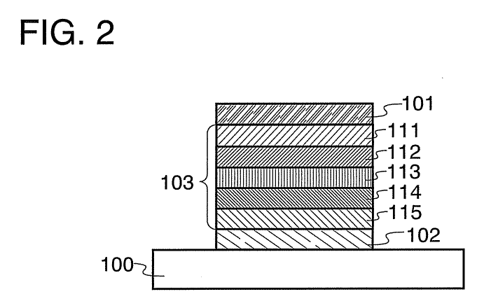

Although FIG. 1 shows a structure in which the first electrode 101 that functions as an anode is disposed on the substrate 100 side, the second electrode 102 that functions as a cathode may be disposed on the substrate 100 side. FIG. 2 shows a structure in which the second electrode 102 that functions as a cathode, the EL layer 103, and the first electrode 101 that functions as an anode are stacked in this order on the substrate 100. In the EL layer 103, the layers are stacked in the reverse order of that shown in FIG. 1.

Any of a variety of methods can be employed for forming the EL layer regardless of whether it is a dry process or a wet process. Further, different deposition methods may be employed for each electrode or layer. A vacuum evaporation method, a sputtering method, or the like can be employed as a dry process. An ink-jet method, a spin-coating method, or the like can be employed as a wet process.

For example, the EL layer may be formed by a wet process with the use of a high molecular compound among the above described materials. The EL layer can alternatively be formed by a wet process with the use of a low molecular compound. Further alternatively, the EL layer may be formed by a dry process such as a vacuum evaporation method with the use of a low molecular organic compound.

It is to be noted that light-emitting layer 113 is formed by a wet process with the use of the composition described in Embodiment Mode 1. Specifically, the composition described in Embodiment Mode 1 is applied by an ink-jet method, a spin coating method, or the like, and then the solvent may be removed. For removing the solvent, a heat treatment, a low pressure treatment, a heat treatment under low pressure, or the like can be employed. The material use efficiency can be improved by employing a wet process, whereby the cost of light-emitting elements can be reduced.

The electrodes may also be formed by a wet process such as a sol-gel process or by a wet process using a metal paste. Alternatively, the electrodes may be formed by a dry process such as a sputtering method or a vacuum evaporation method.

When the light-emitting element described in this embodiment mode is applied to a display device and its light-emitting layer is selectively deposited according to each color, the light-emitting layer is preferably formed by a wet process. When the light-emitting layer is formed by an ink-jet method, selective deposition of the light-emitting layer for each color can be easily performed even in the case of a large sized substrate, and thus productivity is improved.

A specific method for fabricating the light-emitting element is described below.

For example, the structure shown in FIG. 1 can be obtained by the following steps of: forming the first electrode 101 by a sputtering method which is a dry process, forming the hole-injecting layer 111 by an ink-jet method or a spin coating method which is a wet process, forming the hole-transporting layer 112 by a vacuum evaporation method which is a dry process, forming the light-emitting layer 113 by an ink-jet method which is a wet process, forming the electron-transporting layer 114 by a vacuum evaporation method which is a dry process, forming the electron-injecting layer 115 by a vacuum evaporation method which is a dry process, and forming the second electrode 102 by an ink-jet method or a spin coating method which is a wet process. Alternatively, the structure shown in FIG. 1 may be obtained by the steps of: forming the first electrode 101 by an ink-jet method which is a wet process, forming the hole-injecting layer 111 by a vacuum evaporation method which is a dry process, forming the hole-transporting layer 112 by an ink-jet method or a spin coating method which is a wet process, forming the light-emitting layer 113 by an ink-jet method which is a wet process, forming the electron-transporting layer 114 by an ink-jet method or a spin coating method which is a wet process, forming the electron-injecting layer 115 by an ink-jet method or a spin coating method which is a wet process, and forming the second electrode 102 by an ink-jet method or a spin coating method which is a wet process. It is to be noted that the methods are not limited to the above methods, and a wet process and a dry process may be combined as appropriate.

For example, the structure shown in FIG. 1 can be obtained by the steps of: forming the first electrode 101 by a sputtering method which is a dry process, forming the hole-injecting layer 111 and the hole-transporting layer 112 by an ink-jet method or a spin coating method which is a wet process, forming the light-emitting layer 113 by an ink-jet method which is a wet process, forming the electron-transporting layer 114 and the electron-injecting layer 115 by a vacuum evaporation method which is a dry process, and forming the second electrode 102 by a vacuum evaporation method which is a dry process. That is, it is possible to form the hole-injecting layer 111 to the light-emitting layer 113 by wet processes on the substrate having the first electrode 101 which has already been formed in a desired shape, and form the electron-transporting layer 114 to the second electrode 102 thereon by dry processes. By this method, the hole-injecting layer 111 to the light-emitting layer 113 can be formed at atmospheric pressure and the light-emitting layer 113 can be selectively deposited according to each color with ease. In addition, the electron-transporting layer 114 to the second electrode 102 can be consecutively formed in vacuum. Therefore, the process can be simplified, and productivity can be improved.

The process is exemplarily described below. First, PEDOT/PSS is deposited as the hole-injecting layer 111 on the first electrode 101. Since PEDOT/PSS is soluble in water, it can be deposited as an aqueous solution by a spin coating method, an ink-jet method, or the like. The hole-transporting layer 112 is not provided but the light-emitting layer 113 is provided on the hole-injecting layer 111. The light-emitting layer 113 can be formed by an ink-jet method, using the composition, which is described in Embodiment Mode 1, including a solvent (e.g., toluene, dodecylbenzene, a mixed solvent of dodecylbenzene and tetralin, ethers, or alcohols) in which the hole-injecting layer 111 (PEDOT/PSS) which has already been formed is not dissolved. Next, the electron-transporting layer 114 is formed on the light-emitting layer 113. When the electron-transporting layer 114 is formed by a wet process, the electron-transporting layer 114 should be formed using a solvent in which the hole-injecting layer 111 and the light-emitting layer 113 which have already been formed are not dissolved. In that case, the selection range of solvents is limited. Therefore, use of a dry process is easier to form the electron-transporting layer 114. Thus, by consecutively forming the electron-transporting layer 114 to the second electrode 102 in vacuum by a vacuum evaporation method which is a dry process, the process can be simplified.

Meanwhile, a structure shown in FIG. 2 can be formed in the reverse order of the above-described steps: forming the second electrode 102 by a sputtering method or a vacuum evaporation method which is a dry process, forming the electron-injecting layer 115 and the electron-transporting layer 114 by a vacuum evaporation method which is a dry process, forming the light-emitting layer 113 by an ink-jet method which is a wet process, forming the hole-transporting layer 112 and the hole-injecting layer 111 by an ink-jet method or a spin coating method which is a wet process, and forming the first electrode 101 by an ink-jet method or a spin coating method which is a wet process. By this method, the second electrode 102 to the electron-transporting layer 114 can be consecutively formed in vacuum by dry processes, and the light-emitting layer 113 to the first electrode 101 can be formed at atmospheric pressure. Therefore, the process can be simplified, and productivity can be improved. The composition described in Embodiment Mode 1 can be applied to a layer formed by an evaporation method or the like, which allows such a fabrication method.

In this embodiment mode, the light-emitting element is formed over a substrate including glass, plastic, or the like. When a plurality of such light-emitting elements are formed over a substrate, a passive matrix light-emitting device can be manufactured. In addition, it is also possible to form, for example, thin film transistors (TFTs) over a substrate including glass, plastic, or the like and fabricate light-emitting elements over electrodes that are electrically connected to the TFTs. Accordingly, an active matrix light-emitting device in which drive of the light-emitting elements is controlled by the TFTs can be manufactured. There is no particular limitation on the structure of the TFTs, and either staggered TFTs or inversely staggered TFTs may be employed. In addition, a driver circuit formed over a TFT substrate may be constructed from both n-channel and p-channel TFTs or from one of n-channel and p-channel TFTs. Further, there is no particular limitation on the crystallinity of a semiconductor used for forming the TFTs, and either an amorphous semiconductor or a crystalline semiconductor may be used.

The light-emitting element of the present invention fabricated using the composition described in Embodiment Mode 1 is excellent in mass productivity. Also, the fabrication cost is high because of high use efficiency of the material.

Furthermore, the light-emitting element of the present invention including a composition that includes an organometallic complex that is capable of light emission with high emission efficiency has high efficiency.

### Embodiment Mode 3

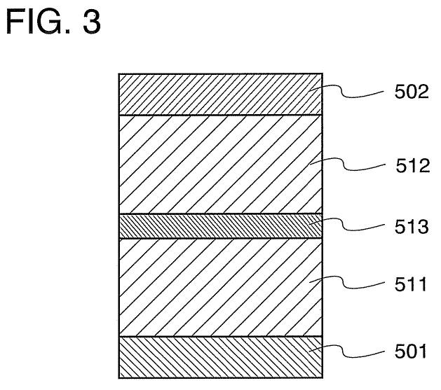

In this embodiment mode, a mode of a light-emitting element in which a plurality of light-emitting units according to the present invention are stacked (hereinafter, referred to as a stacked-type element) is described with reference to FIG. 3. The light-emitting element is a stacked-type light-emitting element including a plurality of light-emitting units between a first electrode and a second electrode. The light-emitting units can be similar to the EL layer described in Embodiment Mode 2. That is, a light-emitting element including one light-emitting unit is described in Embodiment Mode 2, and a light-emitting element including a plurality of light-emitting units is described in this embodiment mode.

In FIG. 3, a first light-emitting unit 511 and a second light-emitting unit 512 are stacked between a first electrode 501 and a second electrode 502. A charge generation layer 513 is provided between the first light-emitting unit 511 and the second light-emitting unit 512. The first electrode 501 and the second electrode 502 can be similar to the electrodes shown in Embodiment Mode 2. The first light-emitting unit 511 and the second light-emitting unit 512 may have either the same or a different structure, which can be similar to that described in Embodiment Mod 2.

The charge generation layer 513 may include a composite material of an organic compound and metal oxide. This composite material of an organic compound and metal oxide has been described in Embodiment Mode 2 and contains an organic compound and metal oxide such as vanadium oxide, molybdenum oxide, or tungsten oxide. As the organic compound, any of a variety of compounds such as an aromatic amine compound, a carbazole derivative, aromatic hydrocarbon, or a high molecular compound (e.g., an oligomer, a dendrimer, or a polymer) can be used. The compound having a hole mobility of 1×10⁻⁶ cm²/Vs or more is preferably used as the organic compound having a hole-transporting property. Any substance other than the above compounds may also be used as long as it is a substance in which the hole-transporting property is higher than the electron-transporting property. A composite of an organic compound with metal oxide is excellent in carrier-injecting property and carrier-transporting property, and hence, low-voltage driving and low-current driving can be achieved.

The charge generation layer 513 may be formed by a combination of a layer including the composite of an organic compound and metal oxide with a layer including any other material. For example, the charge generation layer 513 may be formed by a combination of the layer including the composite of an organic compound and metal oxide with a layer including one compound selected from electron donating substances and a compound having a high electron-transporting property. Alternatively, the charge generation layer 513 may be formed by a combination of a transparent conductive film with a layer including the composite of an organic compound and metal oxide.

The charge generation layer 513 interposed between the first light-emitting unit 511 and the second light-emitting unit 512 may have any structure as long as electrons can be injected to a light-emitting unit on one side and holes can be injected to a light-emitting unit on the other side when voltage is applied between the first electrode 501 and the second electrode 502. For example, an acceptable structure is one in which, in FIG. 3, the charge generation layer 513 injects electrons to the first light-emitting unit 511 and injects holes to the second light-emitting unit 512 when voltage is applied so that the potential of the first electrode is higher than that of the second electrode.

Although the light-emitting element having two light-emitting units is described in this embodiment mode, the present invention can be applied to a light-emitting element in which three or more light-emitting units are stacked. When a plurality of light-emitting units are arranged between a pair of electrodes so that two of the light-emitting units are partitioned with a charge generation layer, like the light-emitting element according to this embodiment mode, high luminance emission can be realized at a low current density, which contributes to enhancement of the life of the light-emitting element. When the light-emitting element is applied to a lighting device, voltage drop due to resistance of the electrode materials can be suppressed, and thus uniform emission in a large area can be realized. Furthermore, a light-emitting device that can drive at a low voltage and consumes low power can be achieved.

When an emission color of each light-emitting unit varies, a desired emission color can be obtained from the light-emitting element as a whole. For example, when an emission color of the first light-emitting unit and an emission color of the second light-emitting unit are complementary colors, it is possible to obtain a light-emitting element having two light-emitting units, from which white light is emitted as a whole. It is to be noted that the complementary colors refer to colors that can produce an achromatic color when they are mixed. That is, white light emission can be obtained by mixture of light from substances, of which the emission colors are complementary colors. This is similarly applied to a light-emitting element having three light-emitting units. For example, white light can be obtained from the light-emitting element as a whole when emission colors of the first, second, and third light-emitting units are red, green, and blue, respectively.

This embodiment mode can be combined with any other embodiment mode as appropriate.

### Embodiment Mode 4

In this embodiment mode, a light-emitting device including a light-emitting element of the present invention is described.

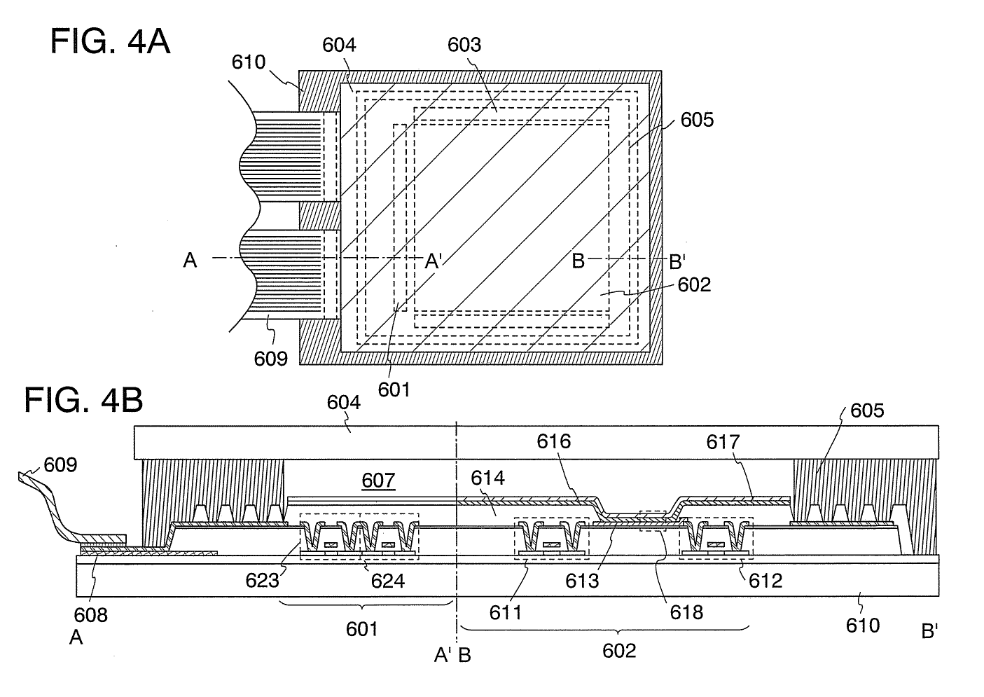

In this embodiment mode, a light-emitting device having the light-emitting element of the present invention in the pixel portion is described using FIGS. 4A and 4B. FIG. 4A is a top view of a light-emitting device, and FIG. 4B is a cross-sectional view of FIG. 4A, taken along lines A-A′ and B-B′. This light-emitting device includes a driver circuit portion (a source side driver circuit) 601; a pixel portion 602; and a driver circuit portion (a gate side driver circuit) 603, which are indicated by dotted lines, so as to control light emission from the light-emitting elements. Reference numeral 604 denotes a sealing substrate; reference numeral 605 denotes a sealing material; and a portion surrounded by the sealing material 605 corresponds to a space 607.

It is to be noted that a lead wiring 608 is a wiring for transmitting signals that are to be inputted to the source side driver circuit 601 and the gate side driver circuit 603. The wiring 608 receives a video signal, a clock signal, a start signal, a reset signal, and the like from a flexible printed circuit (FPC) 609 which is an external input terminal. Although only the FPC is shown in FIGS. 4A and 4B, the FPC may be provided with a printed wiring board (PWB). The category of the light-emitting device in this specification includes not only a light-emitting device itself but also a light-emitting device attached with the FPC or the PWB.

Next, a cross-sectional structure is described using FIG. 4B. Although the driver circuit portions and the pixel portion are formed over an element substrate 610, FIG. 4B shows one pixel in the pixel portion 602 and the source side driver circuit 601 which is one of the driver circuit portions.

A CMOS circuit, which is a combination of an n-channel TFT 623 with a p-channel TFT 624, is formed as the source side driver circuit 601. Each driver circuit portion may be any of a variety of circuits such as a CMOS circuit, PMOS circuit, or an NMOS circuit. Although a driver integration type in which a driver circuit is formed over a substrate provided with a pixel portion is described in this embodiment mode, a driver circuit is not necessarily formed over a substrate provided with a pixel portion and can be formed outside the substrate.

The pixel portion 602 has a plurality of pixels each including a switching TFT 611, a current control TFT 612, and a first electrode 613 which is electrically connected to a drain of the current control TFT 612. An insulator 614 is formed so as to cover end portions of the first electrode 613. In this case, the insulator 614 is formed using a positive photosensitive acrylic resin film.

The insulator 614 is formed so as to have a curved surface having curvature at an upper end portion or a lower end portion thereof in order to make the coverage favorable. For example, in the case of using positive photosensitive acrylic as a material for the insulator 614, it is preferable that the insulator 614 be formed so as to have a curved surface with a curvature radius (0.2 μm to 3 μm) only at the upper end portion thereof. The insulator 614 can be formed using either a negative type which becomes insoluble in an etchant by light irradiation or a positive type which becomes soluble in an etchant by light irradiation.

An EL layer 616 and a second electrode 617 are formed over the first electrode 613. In this case, the first electrode 613 can be formed using any of a variety of metals, alloys, and conductive compounds, a mixture thereof, and the like. When the first electrode functions as an anode, it is preferred that the first electrode be formed using a metal, an alloy, or a conductive compound each having a high work function (a work function of 4.0 eV or higher), or a mixture thereof. For example, the first electrode 613 can be formed using a single-layer film of an indium tin oxide film containing silicon, an indium zinc oxide film, a titanium nitride film, a chromium film, a tungsten film, a Zn film, a Pt film, or the like; or a stacked film, such as a stack of a titanium nitride film and a film containing aluminum as its main component or a three-layer structure of a titanium nitride film, a film containing aluminum as its main component, and a titanium nitride film. When the first electrode 613 has a stacked structure, it can have low resistance as a wiring, form a favorable ohmic contact, and further function as an anode.

The EL layer 616 is formed by any of a variety of methods such as an evaporation method using an evaporation mask using an evaporation mask, an ink-jet method, or a spin coating method. It is to be noted that the EL layer 616 is partly formed using the composition described in Embodiment Mode 1. Either low molecular compounds or high molecular compounds (Oligomers and dendrimers are also included in the category of the high molecular compounds) may be employed as the material used for the EL layer 616. In addition, not only organic compounds but also inorganic compounds may be employed as the material used for the EL layer.

The second electrode 617 can be formed using any of a variety of metals, alloys, and conductive compounds, a mixture thereof, and the like. When the second electrode functions as a cathode, it is preferred that the second electrode be formed using any of a metal, an alloy, and a conductive compound each having a low-work function (a work function of 3.8 eV or lower), or a mixture thereof. For example, any of the following low-work function materials can be used: Group 1 and Group 2 elements of the periodic table, that is, alkali metals such as lithium (Li) and cesium (Cs) and alkaline-earth metals such as magnesium (Mg), calcium (Ca), and strontium (Sr), alloys thereof (MgAg, AlLi), or the like. It is to be noted that, when light emitted from the EL layer 616 is transmitted through the second electrode 617, the second electrode 617 can be formed using a stack of a metal thin film with a reduced thickness and a transparent conductive film (e.g., indium tin oxide (ITO), indium tin oxide containing silicon or silicon oxide, indium zinc oxide (IZO), or indium oxide containing tungsten oxide and zinc oxide (IWZO)).

The sealing substrate 604 is attached to the element substrate 610 with the sealing material 605; thus, a light-emitting element 618 is provided in the space 607 surrounded by the element substrate 610, the sealing substrate 604, and the sealing material 605. The space 607 is filled with a filler such as an inert gas (e.g., nitrogen or argon) or the sealing material 605.

It is preferable that the sealing material 605 be any of epoxy-based resins and such materials permeate little moisture and oxygen as much as possible. As the sealing substrate 604, a plastic substrate made of fiberglass-reinforced plastics (FRP), polyvinyl fluoride (PVF), polyester, acrylic, or the like can be used as well as a glass substrate or a quartz substrate.

Accordingly, the light-emitting device having the light-emitting element of the present invention can be obtained.

The light-emitting device of the present invention manufactured using the composition described in Embodiment Mode 1 is excellent in mass productivity. Also, the manufacturing cost is reduced because of high use efficiency of the material, whereby a low cost light-emitting device can be obtained.

Furthermore, the light-emitting device of the present invention having a light-emitting element with high emission efficiency consumes low power.

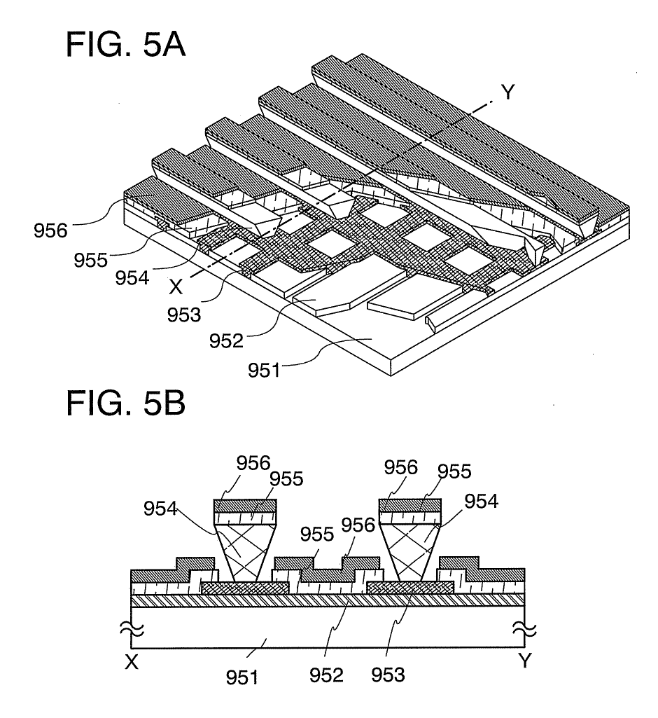

Although an active matrix light-emitting device in which driving of a light-emitting element is controlled by transistors is described in this embodiment mode as described above, the light-emitting device may be replaced with a passive matrix light-emitting device. FIGS. 5A and 5B show a passive matrix light-emitting device to which the present invention is applied. FIG. 5A is a perspective view of the light-emitting device, and FIG. 5B is a cross-sectional view taken along a line X-Y of FIG. 5A. In FIGS. 5A and 5B, an EL layer 955 is provided between an electrode 952 and an electrode 956 over a substrate 951. End portions of the electrode 952 are covered with an insulating layer 953. Then, a partition layer 954 is provided over the insulating layer 953. A side wall of the partition layer 954 slopes so that a distance between one side wall and the other side wall becomes narrow toward the substrate surface. In other words, a cross section taken in the direction of the short side of the partition layer 954 is trapezoidal, and the base of the cross-section (a side facing in the same direction as a plane direction of the insulating layer 953 and in contact with the insulating layer 953) is shorter than the upper side thereof (a side facing in the same direction as the plane direction of the insulating layer 953 and not in contact with the insulating layer 953). A cathode can be patterned by providing the partition layer 954 in this manner. The passive matrix light-emitting device can also operate with low power consumption when it includes the light-emitting element having high emission efficiency.

### Embodiment Mode 5

In this embodiment mode, electronic devices of the present invention, each including the light-emitting device described in Embodiment Mode 4, are described. The electronic devices of the present invention each have a display portion manufactured using the composition described in Embodiment Mode 1. In addition, the display portion consumes lower power.

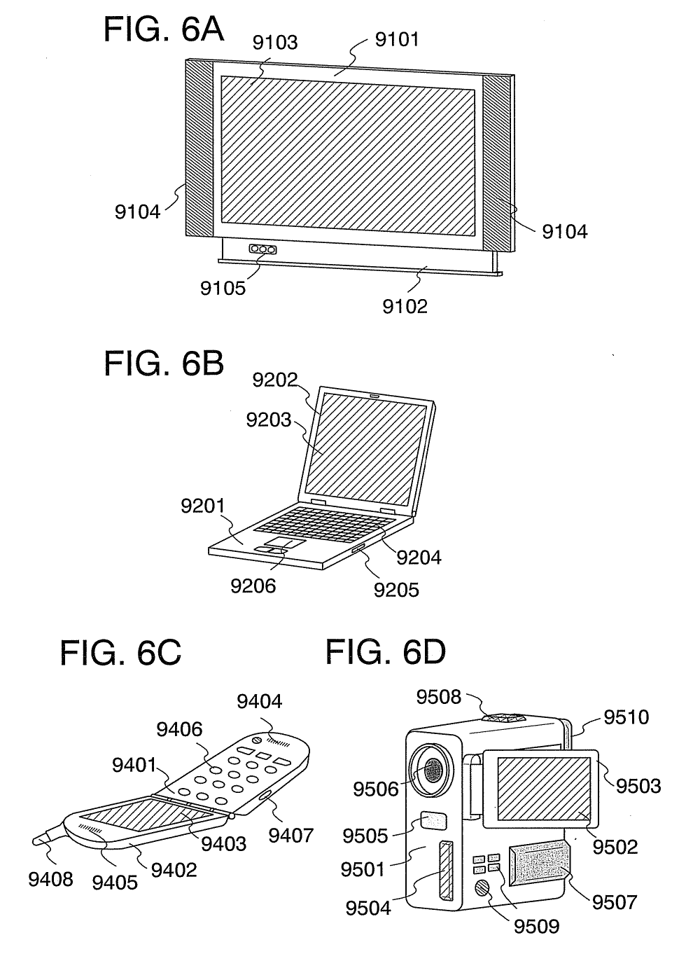

Examples of the electronic devices each having the light-emitting element fabricated using the composition of the present invention include cameras such as video cameras or digital cameras, goggle type displays, navigation systems, audio reproducing devices (e.g., car audio components and audio components), computers, game machines, portable information terminals (e.g., mobile computers, cellular phones, portable game machines, and e-book readers), and image reproducing devices provided with recording media (specifically, devices that are capable of reproducing recording media such as digital versatile discs (DVDs) and each provided with a display device that can display the image). Specific examples of these electronic devices are shown in FIGS. 6A to 6D.

FIG. 6A shows a television device according to the present invention, which includes a chassis 9101, a supporting base 9102, a display portion 9103, a speaker portion 9104, a video input terminal 9105, and the like. In the television device, the display portion 9103 includes light-emitting elements similar to those described in Embodiment Modes 2 and 3, which are arranged in matrix. The light-emitting elements are characterized by high emission efficiency. The display portion 9103 which includes the light-emitting elements has similar characteristics. Accordingly, the television device consumes low power. Such characteristics can dramatically reduce or downsize power supply circuits in the television device, whereby the chassis 9101 and the supporting base 9102 can be reduced in size and weight. In the television device according to the present invention, low power consumption, high image quality, and reduced size and weight are achieved; therefore, a product suitable for living environment can be provided.

FIG. 6B shows a computer according to the present invention, which includes a main body 9201, a chassis 9202, a display portion 9203, a keyboard 9204, an external connection port 9205, a pointing device 9206, and the like. In the computer, the display portion 9203 includes light-emitting elements similar to those described in Embodiment Modes 2 and 3, which are arranged in matrix. The light-emitting elements are characterized by high emission efficiency. The display portion 9203 which includes the light-emitting elements has similar characteristics. Accordingly, the computer consumes low power. Such characteristics can dramatically reduce or downsize power supply circuits in the computer, whereby the main body 9201 and the chassis 9202 can be reduced in size and weight. In the computer according to the present invention, low power consumption, high image quality, and reduced size and weight are achieved; therefore, a product suitable for the environment can be provided.

FIG. 6C shows a cellular phone according to the present invention, which includes a main body 9401, a chassis 9402, a display portion 9403, an audio input portion 9404, an audio output portion 9405, an operation key 9406, an external connection port 9407, an antenna 9408, and the like. In the cellular phone, the display portion 9403 includes light-emitting elements similar to those described in Embodiment Modes 2 and 3, which are arranged in matrix. The light-emitting elements are characterized by high emission efficiency. The display portion 9403 which includes the light-emitting elements has similar characteristics. Accordingly, the cellular phone consumes low power. Such characteristics can dramatically reduce or downsize power supply circuits in the cellular phone, whereby the main body 9401 and the chassis 9402 can be reduced in size and weight. In the cellular phone according to the present invention, low power consumption, high image quality, and a small size and light weight are achieved; therefore, a product suitable for carrying can be provided.

FIG. 6D shows a camera according to the present invention, which includes a main body 9501, a display portion 9502, a chassis 9503, an external connection port 9504, a remote control receiving portion 9505, an image receiving portion 9506, a battery 9507, an audio input portion 9508, operation keys 9509, an eye piece portion 9510, and the like. In the camera, the display portion 9502 includes light-emitting elements similar to those described in Embodiment Modes 2 and 3, which are arranged in matrix. The light-emitting elements are characterized by high emission efficiency. The display portion 9502 which includes the light-emitting elements has similar characteristics. Accordingly, the camera consumes low power. Such characteristics can dramatically reduce or downsize power supply circuits in the camera, whereby the main body 9501 can be reduced in size and weight. In the camera according to the present invention, low power consumption, high image quality, and reduced size and weight are achieved; therefore, a product suitable for carrying can be provided.

As described above, the applicable range of the light-emitting device of the present invention is so wide that the light-emitting device can be applied to electronic devices in various fields. By use of the light-emitting element of the present invention, an electronic device including a display portion with low power consumption can be provided. Furthermore, the electronic device of the present invention including the light-emitting element manufactured using the composition described in Embodiment Mode 1 is excellent in mass productivity. Also, the manufacturing cost is reduced because of high use efficiency of the material, whereby a low cost electronic device can be obtained.

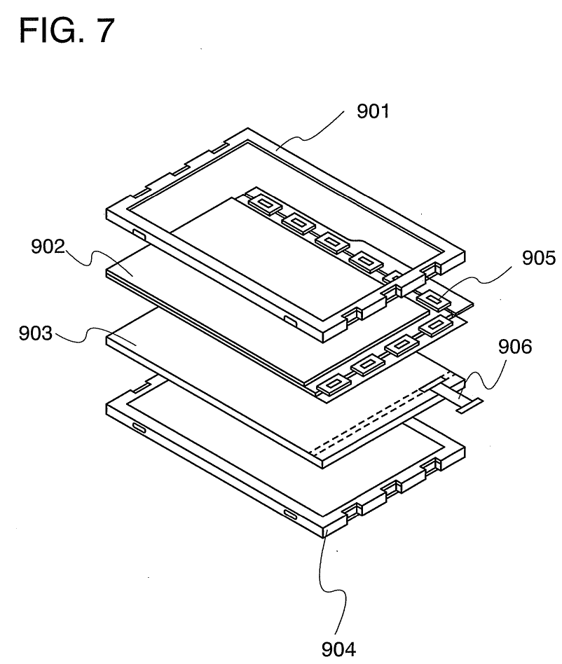

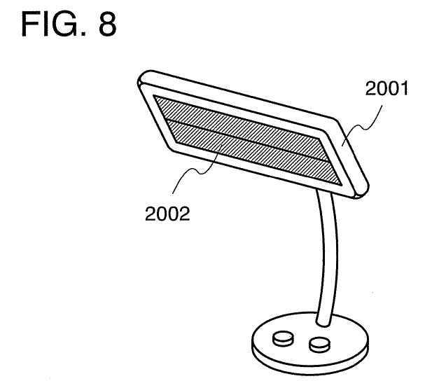

The light-emitting device of the present invention can also be used as a lighting device. One mode in which the light-emitting device of the present invention is used as the lighting device is described using FIG. 7.

FIG. 7 shows an example of a liquid crystal display device in which the light-emitting device of the present invention is used as a backlight. The liquid crystal display device shown in FIG. 7 includes a chassis 901, a liquid crystal layer 902, a backlight 903, and a chassis 904. The liquid crystal layer 902 is connected to a driver IC 905. The light-emitting device of the present invention is used as the backlight 903, and current is supplied through a terminal 906.

When the light-emitting device of the present invention is used as the backlight of the liquid crystal display device, the backlight can reduce its power consumption. The light-emitting device of the present invention is a lighting device with plane emission area, and this emission area can be readily increased; accordingly, it is possible that the backlight has a larger emission area and the liquid crystal display device has a larger display area. Further, the light-emitting device of the present invention has a thin shape and consumes low power; thus, the display device can also be reduced in thickness and power consumption. Furthermore, the light-emitting device of the present invention manufactured using the composition described in Embodiment Mode 1 is excellent in mass productivity. Also, the manufacturing cost is reduced because of high use efficiency of the material, whereby a low cost light-emitting device can be obtained. Accordingly, the liquid crystal display device to which the light-emitting device of the present invention is applied has similar features.

FIG. 8 shows an example in which the light-emitting device of the present invention is used as a table lamp that is a lighting device. A table lamp shown in FIG. 8 has a chassis 2001 and a light source 2002, and the light-emitting device of the present invention is used as the light source 2002. The light-emitting device of the present invention can emit light with high luminance, and thus it can illuminate the area where detail work or the like is being done. The light-emitting device of the present invention manufactured using the composition described in Embodiment Mode 1 is excellent in mass productivity. Also, the manufacturing cost is reduced because of high use efficiency of the material, whereby a low cost light-emitting device can be obtained.

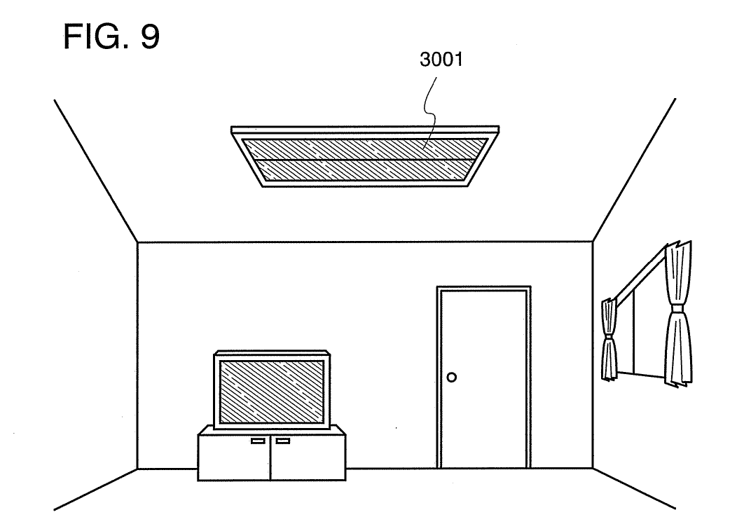

FIG. 9 shows an example in which the light-emitting device of the present invention is used as an indoor lighting device 3001. Since the light-emitting device of the present invention can have a larger emission area, the light-emitting device of the present invention can be used as a lighting device having a larger emission area. Further, the light-emitting device of the present invention has a thin shape and consumes low power; accordingly, the light-emitting device of the present invention can be used as a lighting device having a thin shape and consuming low power. When a television device according to the present invention as described using FIG. 6A is placed in a room in which a light-emitting device to which the present invention is applied is used as the indoor lighting device 3001, public broadcasting and movies can be watched. In such a case, since both of the devices consume low power, a powerful image can be watched in a bright room without concern about electricity charges.

### Embodiment 1

In Example 1, the solubility of an organometallic complex having a pyrazine skeleton as described in Embodiment Mode 1 was evaluated. The evaluation was performed by examining the solubility in various solvents. For the solvent, toluene and anisole were each used as a solvent having an aromatic ring. Further, diethyl ether which is ether, and 2-ethoxyethanol, isopropanol, ethanol, and methanol which are alcohols were each used as a solvent not having an aromatic ring.

A total of 12 substances represented by the structural formulae (1), (3), (11), (17), (18), (19), (20), (25), (33), (36), (44), and (45) were selected as samples to be evaluated, among the complexes each having a pyrazine skeleton, which are disclosed in Embodiment Mode 1, and the solubility of each sample was examined. In addition, the solubility of btp₂Ir(acac) (a structural formula (101) given below), which is disclosed in Nonpatent Document 1 was evaluated as a comparative sample A. In addition, the solubility of Ir(ppy)₂(acac) (a structural formula (102) given below) was evaluated as a comparative sample B.

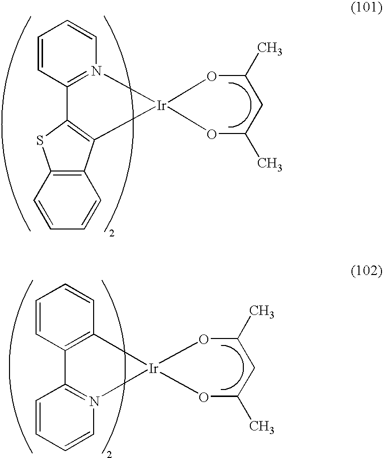

Results of the solubility test of each sample are shown in Table 1 given below. In Table 1, a solubility x [g/L] is indicated by a cross in the case of x<0.6, a triangle in the case of 0.9>x≧0.6, a circle in the case of 1.2>x≧0.9, or a double circle in the case of x≧1.2.

TABLE 1

| | | | | | | Solvents not having aromatic ring | | | | |
|---|---|---|---|---|---|---|---|---|---|---|
| | | Structural | | Solvents having | | Ether | Alcohol | | | |
| | Sample | formula | | aromatic ring | | diethyl | 2-ethoxy | | | |
| | No. | No. | Compound abbreviation | toluene | anisole | ether | ethanol | isopropanol | ethanol | methanol |
| Comparative | A | (101) | btp₂Ir(acac) | X | ◯ | X | Δ | X | X | X |
| samples | B | (102) | Ir(ppy)₂(acac) | ◯ | ⊚ | X | Δ | X | X | X |
| Samples | 1 | (1) | Ir(dppr)₂(acac) | ◯ | ⊚ | X | X | X | X | X |
| | 2 | (3) | Ir(Fdppr)₂(acac) | ◯ | ⊚ | X | X | X | X | X |
| | 3 | (11) | Ir(mppr)₂(acac) | ⊚ | ⊚ | X | X | X | X | X |
| | 4 | (17) | Ir(Fdppr-Me)₂(acac) | ⊚ | ⊚ | ⊚ | ⊚ | X | X | X |
| | 5 | (18) | Ir(Fdppr-Me)₂(pic) | ⊚ | ⊚ | X | ⊚ | ⊚ | ⊚ | X |
| | 6 | (19) | Ir(Fdppr-Me)₂(bpz4) | ⊚ | ⊚ | ⊚ | ⊚ | ⊚ | ⊚ | ⊚ |
| | 7 | (20) | Ir(Fdppr-iPr)₂(pic) | ⊚ | ⊚ | X | ⊚ | X | X | X |
| | 8 | (25) | Ir(CF3dppr-Me)₂(pic) | ⊚ | ⊚ | ⊚ | ⊚ | ⊚ | ⊚ | ⊚ |
| | 9 | (33) | Ir(mppr-iPr)₂(acac) | ⊚ | ⊚ | ⊚ | ⊚ | Δ | Δ | X |
| | 10 | (36) | Ir(tppr)₂(acac) | ⊚ | ⊚ | ⊚ | ⊚ | X | X | X |
| | 11 | (44) | Ir(Mdppr-P)₂(acac) | ⊚ | ⊚ | ⊚ | ⊚ | ◯ | ⊚ | X |
| | 12 | (45) | Ir(Mdppr-3FP)₂(acac) | ⊚ | ⊚ | ⊚ | ⊚ | ⊚ | ⊚ | X |

First, each of the samples 1 to 12 (the organometallic complexes each having a pyrazine skeleton) has a high solubility compared with the comparative sample A (btp₂Ir(acac)), which exhibits a sufficiently high solubility (0.9 g/L or more) in each of toluene and anisole which are solvents each having an aromatic ring. Therefore, use of each of samples 1 to 12 is preferable for a composition for application, which is used in a light-emitting element fabricated by a wet process.

Even though each of the samples 1 to 3 has relatively a low solubility among the organometallic complexes each having a pyrazine skeleton and dissolved only in toluene and anisole, each sample has a solubility nearly equal to or higher than that of the comparative sample B (Ir(ppy)₂(acac)), which has a low molecular weight and relatively high solubility. It is to be noted that the samples 1 to 3 are complexes represented by the general formula (G1) or (G2), in which R¹ is hydrogen.

It is found that each of the samples 4 to 12 has high solubility not only in toluene and anisole, but also in diethyl ether that is ether, in which the comparative sample B (Ir(ppy)₂(acac)) has low solubility, and even in 2-ethoxyethanol that is alcohol. That is, each of the samples 4 to 12 has much higher solubility than the comparative samples. It is found that all of the samples 4 to 12 each have extremely high solubility (1.2 g/L or more) particularly in 2-ethoxyethanol.

The samples 4 to 9 are complexes represented by the general formula (G1) or (G2), in which R¹ is an alkyl group, and the samples 10 to 12 are complexes represented by the general formula (G1) or (G2), in which R¹ is an aryl group. Accordingly, the present inventors have found that complexes represented by the general formula (G1) or (G2) have higher solubility by introduction of a substituent (an alkyl group or an aryl group) into R¹. In particular, like the samples 10 to 12, improvement of solubility, despite the introduction of a rigid aryl group, in a solvent not having an aromatic ring (ethers and alcohols in Table 1) can be considered as highly characteristic.

### Embodiment 2

In Example 2, preparation of a composition for application of the present invention and fabrication of a light-emitting element using the composition are exemplified.

### <<Preparation of Composition 1 for Application of the Present Invention>>

First, in a mixed solvent (30.8 mL) of toluene (15.4 mL) and chloroform (15.4 mL) were dissolved 0.194 g of poly(N-vinylcarbazole) (PVK) (manufactured by Aldrich, Mn=42,000) which is an organic semiconductor of a high molecular compound, 0.117 g of 4-(9H-carbazol-9-yl)-4′-(5-phenyl-1,3,4-oxadiazol-2-yl)triphenylamine (YGAO11) which is an organic semiconductor of a low molecular compound, and 0.017 g of (acetylacetonato)bis(2,3,5-triphenylpyrazinato)iridium(III) (Ir(tppr)₂(acac)), represented by the structural formula (36) in Embodiment Mode 1) which is an organometallic complex having a pyrazine skeleton; thus, a composition 1 for application of the present invention was prepared. Structural formulae of PVK, YGAO11, and Ir(tppr)₂(acac) are shown below.

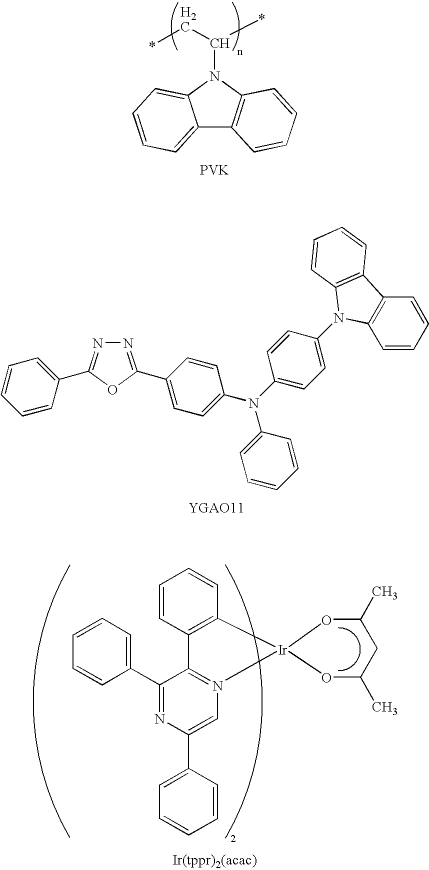

### <<Fabrication of Light-emitting Element 1 of the Present Invention>>

Next, a method for fabricating a light-emitting element 1 of the present invention is described below. First, a glass substrate on which indium tin silicon oxide (ITSO) was deposited to a thickness of 110 nm was prepared. The periphery of surface of the ITSO was covered with a polyimide film so that an area of 2 mm×2 mm of the surface was exposed. It is to be noted that the ITSO functions as an anode of the light-emitting element. As a pretreatment for forming the light-emitting element on this substrate, a mixed solution of water and 2-ethoxyethanol that were mixed in a volume ratio of 3:2 was dropped onto the ITSO, and the ITSO was spin-coated with the mixed solution.

Next, 15 mL of PEDOT/PSS (produced by H. C. Starck GmbH, A14083sp.gr) and 10 mL of 2-ethoxyethanol were mixed to prepare a mixed solution, and this mixed solution was dropped onto the ITSO. Immediately thereafter, the ITSO was spin-coated with the mixed solution at a spinning rate of 2000 rpm for 60 seconds, and then at a spinning rate of 3000 rpm for 10 seconds. Then, after an end portion of the substrate was wiped so as to expose a terminal connected to the ITSO, baking was performed at 110° C. for two hours in a vacuum dryer in which the pressure is reduced with a rotary pump; accordingly, PEDOT/PSS was deposited to a thickness of 50 nm as a hole-injecting layer on the ITSO.

Next, in a glove box, the PEDOT/PSS was spin-coated with the composition 1 for application of the present invention which had already been prepared where the oxygen concentration was 10 ppm or less. The spin coating was carried out at a spinning rate of 300 rpm for 5 seconds, and then at a spinning rate of 1000 rpm for 55 seconds. Then, after an end portion of the substrate was wiped so as to expose a terminal connected to the ITSO, baking was performed at 70° C. for 10 minutes under normal pressure, and then 70° C. for 20 minutes under reduced pressure; accordingly, a light-emitting layer was formed on the PEDOT/PSS.

Then, the substrate was fixed to a holder provided in a vacuum evaporation apparatus so that the surface provided with the ITSO faced downward.

After the pressure in the vacuum evaporation apparatus was reduced to 10⁻⁴ Pa, bis(2-methyl-8-quinolinolato)(4-phenylphenolato)aluminum(III) (BAlq) was deposited to a thickness of 10 nm, whereby a first electron-transporting layer was formed. Furthermore, bathophenanthroline (BPhen) was deposited to a thickness of 40 nm on the first electron-transporting layer, whereby a second electron-transporting layer was formed. Furthermore, lithium fluoride (LiF) was deposited to a thickness of 1 nm on the second electron-transporting layer, whereby an electron-injecting layer was formed. Lastly, aluminum was deposited to a thickness of 200 nm as a cathode, whereby the light-emitting element of the present invention was obtained. It is to be noted that, in the above evaporation process, evaporation was all performed by a resistance heating method. Structural formulae of BAlq and BPhen are shown below.

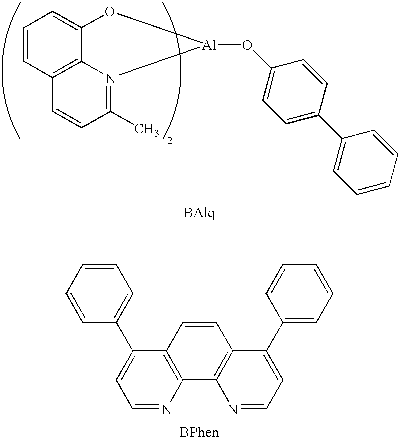

### <<Operation Characteristics of the Light-emitting Element 1>>

After the light-emitting element 1 obtained as described above was sealed in a glove box under a nitrogen atmosphere so as not to be exposed to the air, operation characteristics of the light-emitting element was measured. It is to be noted that the measurement was performed at room temperature (an atmosphere kept at 25° C.).

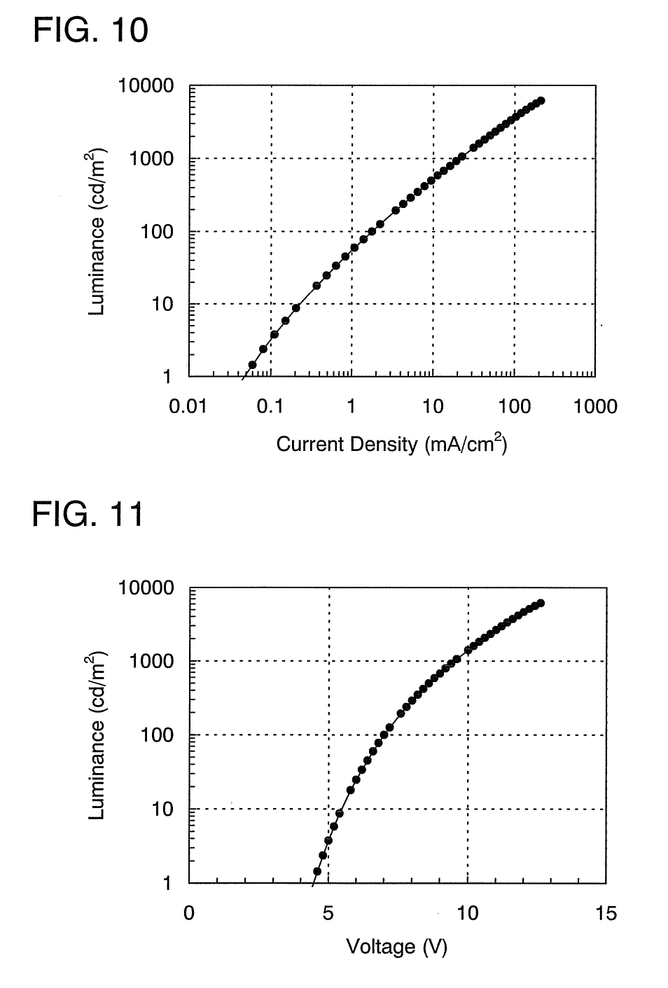

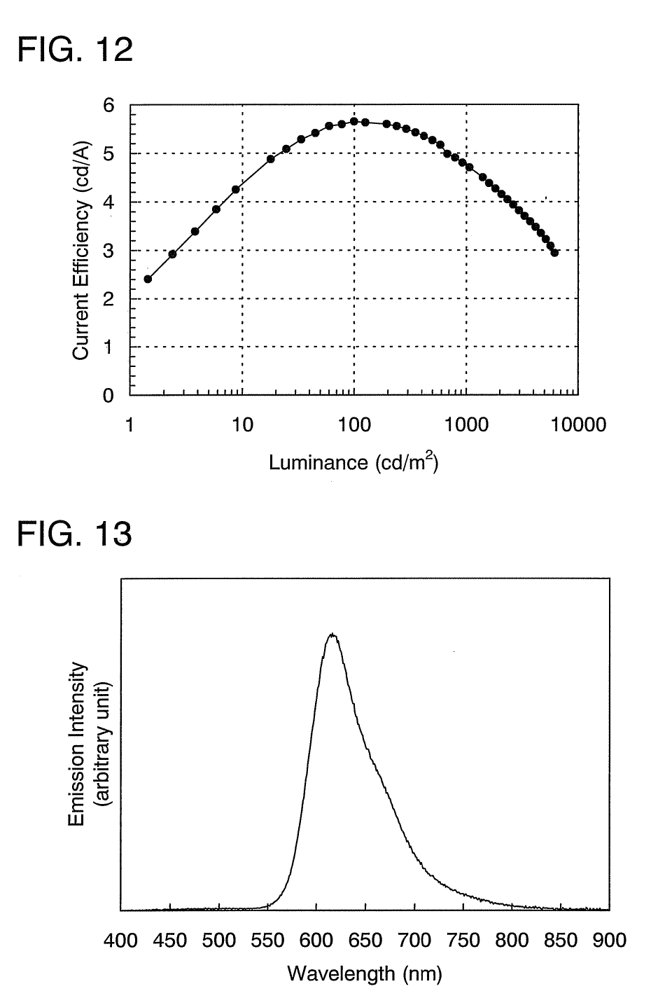

Current density-luminance characteristics, voltage-luminance characteristics, and luminance-current efficiency characteristics of the light-emitting element 1 are shown in FIGS. 10, 11, and 12, respectively. Also, the emission spectrum measured at current of 1 mA is shown in FIG. 13.

When the luminance of the light-emitting element 1 was 1060 cd/m², the CIE color coordinates were x=0.65 and y=0.35 and the emission color was red; the current efficiency was 4.7 cd/A, which is indicative of high efficiency. The voltage was 9.6 V, the current density was 22.5 mA/cm², and the power efficiency was 1.5 lm/W, which is indicative of high power efficiency. The peak wavelength of the emission spectrum was 616 nm as shown in FIG. 13.

Therefore, a light-emitting element to which the present invention is applied can have high emission efficiency and consumes low power.

It is found that the use of the composition of the present invention enables further film formation by a wet process on a layer including an organic compound. Therefore, fabrication using the composition of the present invention is excellent in mass productivity and suitable for industrial application. Furthermore, such fabrication can achieve high material use efficiency and lower fabrication cost.

### Embodiment 3

In Example 3, preparation of a composition for application of the present invention and fabrication of a light-emitting element using the composition are exemplified.

### <<Preparation of Composition 2 for Application of the Present Invention>>

First, in a mixed solvent (25.4 mL) of toluene (12.7 mL) and chloroform (12.7 mL) were dissolved 0.116 g of poly(methylmethacrylate) (PMMA) (manufactured by Aldrich, Mw=996,000) which is a binder polymer, 0.151 g of 4,4′-(quinoxaline-2,3-diyl)bis[N-(biphenyl-4-yl)-N-phenylaniline (BPAPQ) which is an organic semiconductor of a low molecular compound, and 0.019 g of (acetylacetonato)bis(2,3,5-triphenylpyrazinato)iridium(III) (Ir(tppr)₂(acac)), represented by the structural formula (36) in Embodiment Mode 1) which is an organometallic complex having a pyrazine skeleton; thus, a composition 2 for application of the present invention was prepared. Structural formulae of PMMA, BPAPQ, and Ir(tppr)₂(acac) are shown below.

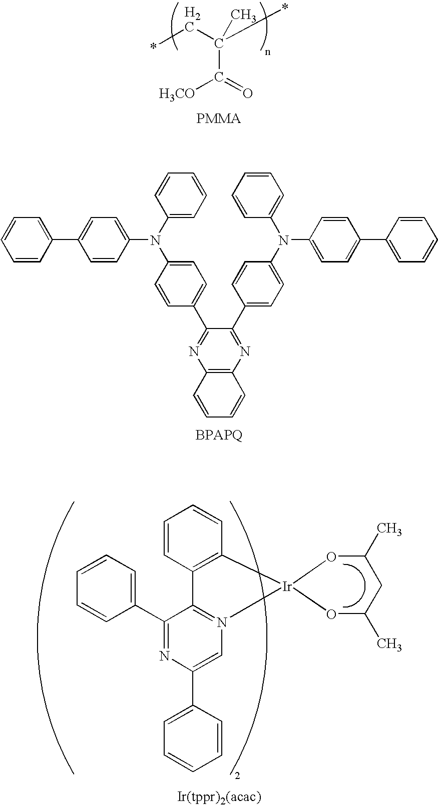

### <<Fabrication of Light-emitting Element 2 of the Present Invention>>

The light-emitting element 2 was fabricated in a similar manner to the light-emitting element 1 except that the composition 2 for application of the present invention was used instead of the composition 1 for application of the present invention.

### <<Operation Characteristics of the Light-emitting Element 2>>

After the light-emitting element 2 obtained as described above was sealed in a glove box under a nitrogen atmosphere so as not to be exposed to the air, operation characteristics of the light-emitting element was measured. It is to be noted that the measurement was performed at room temperature (an atmosphere kept at 25° C.).

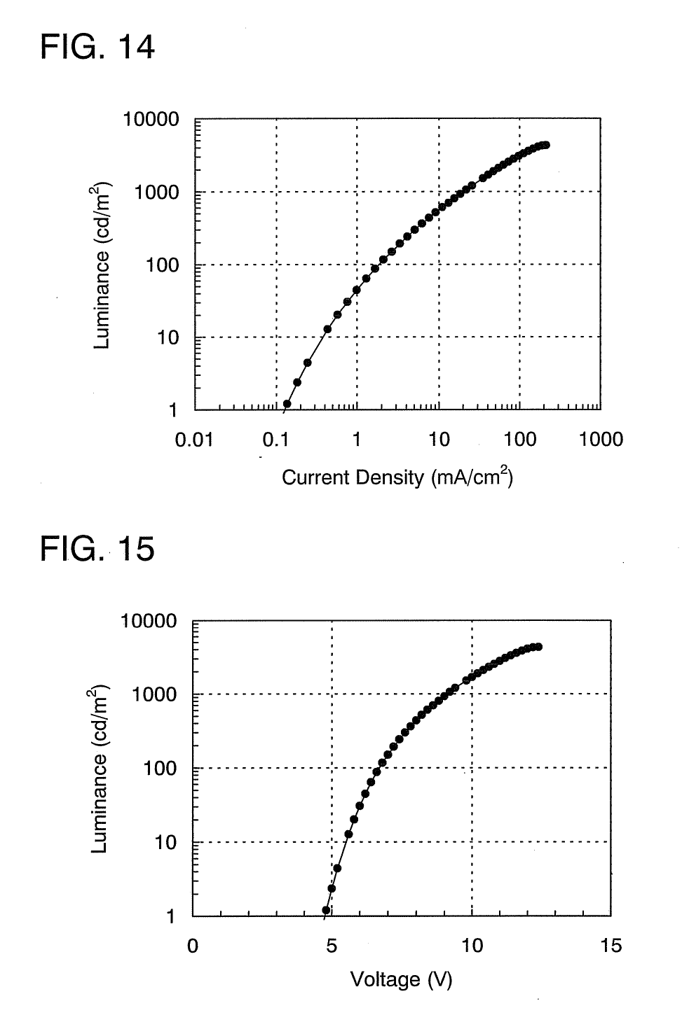

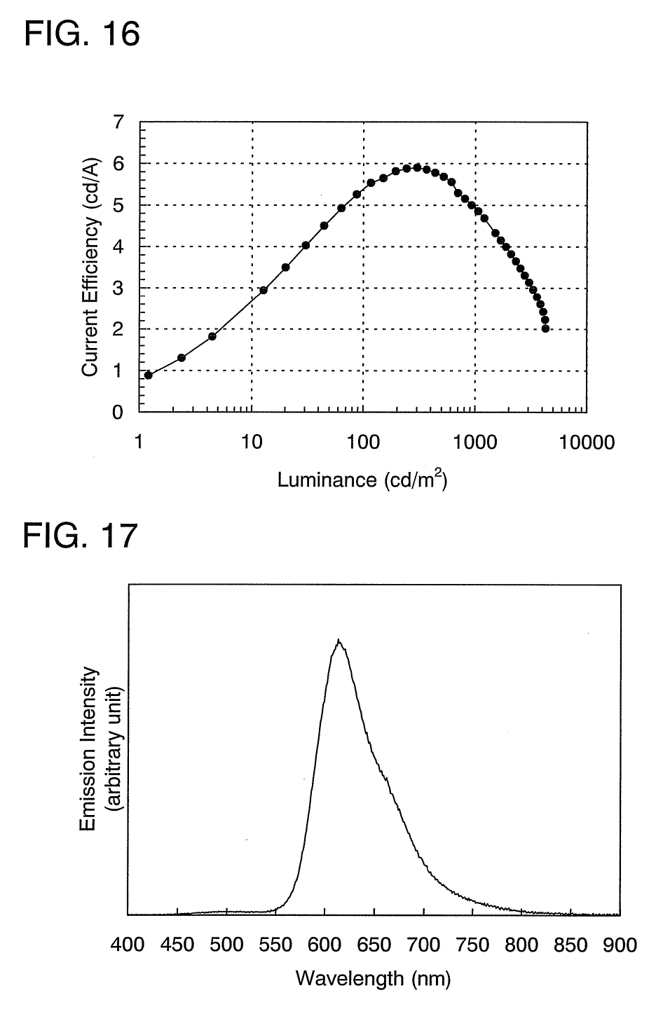

Current density-luminance characteristics, voltage-luminance characteristics, and luminance-current efficiency characteristics of the light-emitting element 2 are shown in FIGS. 14, 15, and 16, respectively. Also, the emission spectrum measured at current of 1 mA is shown in FIG. 17.

When the luminance of the light-emitting element 2 was 1060 cd/m², the CIE color coordinates were x=0.64 and y=0.36 and the emission color was red; the current efficiency was 4.9 cd/A, which is indicative of high efficiency. The voltage was 9.2 V, the current density was 21.8 mA/cm², and the power efficiency was 1.7 lm/W, which is indicative of high power efficiency. The peak wavelength of the emission spectrum was 613 nm as shown in FIG. 17.

Therefore, a light-emitting element to which the present invention is applied can have high emission efficiency and consumes low power.

It is found that a layer can further be formed on a layer including an organic compound by a wet process by use of the composition of the present invention. Therefore, fabrication using the composition of the present invention is excellent in mass productivity and suitable for industrial application. Furthermore, such fabrication can achieve high material use efficiency and lower fabrication cost.

### Embodiment 4

In Example 4, preparation of a composition for application of the present invention and fabrication of a light-emitting element using the composition are exemplified.

### <<Preparation of Composition 3 for Application of the Present Invention>>

First, in 30 mL of 2-methoxyethanol (produced by Kanto Chemical Co., Inc.) was dissolved 0.45 g of bis(2-methyl-8-quinolinolato)(4-phenylphenolato)aluminum(III) (BAlq) (produced by Chemipro Kasei Kaisha, Ltd., a product purified by sublimation) which is an organic semiconductor of a low molecular compound, 0.026 g of N,A-bis(3-methylphenyl)-NAT-diphenyl-[1,1′-biphenyl]-4,4′-diamine (TPD) (produced by Kanto Chemical Co. Inc., Ltd.), and 0.047 g of (acetylacetonato)bis(2,3,5-triphenylpyrazinato)iridium(III) (Ir(tppr)₂(acac)), represented by the structural formula (36) in Embodiment Mode 1) which is an organometallic complex having a pyrazine skeleton; thus, a composition 3 for application of the present invention was prepared. It is to be noted that the composition was bubbled with argon for one hour in order to remove oxygen immediately before the spin coating. Structural formulae of BAlq, TPD, and Ir(tppr)₂(acac) are shown below.

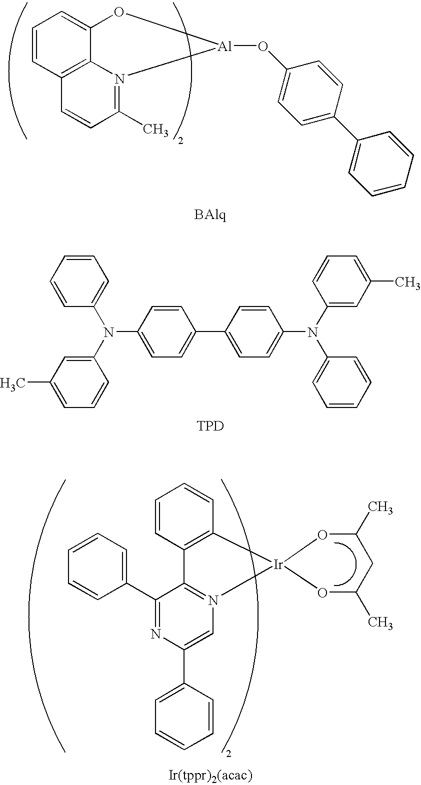

### <<Preparation of Solution A>>

In 40 mL of 1,4-dioxane (dehydration) (produced by Kanto Chemical Co. Inc.) were dissolved 0.10 g of poly(N-vinylcarbazole) (PVK) (manufactured by Aldrich, Mw=1100000) and 0.0255 g of 4,4′-bis[N-(1-naphthyl)-N-phenylamino]biphenyl (NPB) (produced by Chemipro Kasei Kaisha, Ltd., a product purified by sublimation); accordingly, a solution A was prepared.

### <<Fabrication of Light-emitting Element 3 of the Present Invention>>

Next, a method for fabricating a light-emitting element 3 of the present invention is described below. First, a glass substrate on which indium tin silicon oxide (ITSO) was deposited to a thickness of 110 nm was prepared. The periphery of surface of the ITSO was covered with a polyimide film so that an area of 2 mm×2 mm of the surface was exposed. It is to be noted that the ITSO functions as an anode of the light-emitting element. As a pretreatment for forming the light-emitting element, a mixed solution of water and 2-ethoxyethanol that were mixed in a volume ratio of 3:2 was dropped into the ITSO, and the ITSO was spin-coated with the mixed solution.

Next, 15 mL of PEDOT/PSS (produced by H. C. Starck GmbH, AI4083sp.gr) and 10 mL of 2-ethoxyethanol were mixed to prepare a mixed solution, and this mixed solution was dropped onto the ITSO. Immediately thereafter, the ITSO was spin-coated with the mixed solution at a spinning rate of 2000 rpm for 60 seconds, and then at a spinning rate of 3000 rpm for 10 seconds. Then, after an end portion of the substrate was wiped so as to expose a terminal connected to the ITSO, baking was performed at 110° C. for two hours in a vacuum dryer in which the pressure is reduced with a rotary pump; accordingly, PEDOT/PSS was deposited to a thickness of 50 nm as a hole-injecting layer on the ITSO.

Next, in a glove box, the PEDOT/PSS was spin-coated with the solution A which had already been prepared (at an oxygen concentration of 20 ppm or less and a moisture concentration of 10 ppm or less). The spin coating was carried out at a spinning rate of 300 rpm for 2 seconds, then at a spinning rate of 1000 rpm for 60 seconds, and further at a spinning rate of 2500 rpm for 10 seconds. Then, after an end portion of the substrate was wiped so as to expose a terminal connected to the ITSO, vacuum heat drying was performed at 120° C. for one hour in a vacuum dryer in which the pressure is reduced with a rotary pump; accordingly, the hole-transporting layer was formed. When the solution A was deposited on a glass substrate under the above film formation conditions, the film thickness was found to be 15 nm by measurement using a surface profiler (Dektak V200Si, manufactured by Ulvac, Inc.)

Next, in a glove box, the hole-transporting layer was spin-coated with the composition 3 for application of the present invention which had already been prepared (at an oxygen concentration of 20 ppm or less and a moisture concentration of 10 ppm or less). The spin coating was carried out at a spinning rate of 300 rpm for 2 seconds, then at a spinning rate of 500 rpm for 60 seconds, and further at a spinning rate of 2500 rpm for 10 seconds. Then, after an end portion of the substrate was wiped so as to expose a terminal connected to the ITSO, vacuum heat drying was performed at 100° C. for one hour in a vacuum dryer in which the pressure is reduced with a rotary pump; accordingly, the light-emitting layer was formed. When the composition 3 for application of the present invention was deposited on a glass substrate under the above film formation conditions, the film thickness was found to be 40 nm by measurement using a surface profiler (Dektak V200Si, manufactured by Ulvac, Inc.)

Then, the substrate was fixed to a holder provided in a vacuum evaporation apparatus so that the surface provided with the ITSO faced downward.

After the pressure in the vacuum evaporation apparatus was reduced to 10⁻⁴ Pa, bis(2-methyl-8-quinolinolato)(4-phenylphenolato)aluminum(III) (BAlq) was deposited to a thickness of 10 nm, whereby a first electron-transporting layer was formed. Furthermore, bathophenanthroline (BPhen) was deposited to a thickness of 20 nm on the first electron-transporting layer, whereby a second electron-transporting layer was formed. Furthermore, lithium fluoride (LiF) was deposited to a thickness of 1 nm on the second electron-transporting layer, whereby an electron-injecting layer was formed. Lastly, aluminum was deposited to a thickness of 200 nm as a cathode, whereby the light-emitting element of the present invention was obtained. It is to be noted that, in the above evaporation process, evaporation was all performed by a resistance heating method.

### <<Fabrication of Light-emitting Element 4 of the Present Invention>>

Next, a method for fabricating a light-emitting element 4 of the present invention is described below. In the light-emitting element 4, bathophenanthroline (BPhen) was deposited to a thickness of 30 nm on a light-emitting layer, whereby an electron-transporting layer was formed, and then lithium fluoride (LiF) was deposited to a thickness of 1 nm on the electron-transporting layer, whereby an electron-injecting layer was formed. The fabrication process for the rest was similar to that of the light-emitting element 3.

### <Operation Characteristics of the Light-emitting Elements 3 and 4>>

After the light-emitting elements 3 and 4 obtained as described above were sealed in a glove box under a nitrogen atmosphere so as not to be exposed to the air, operation characteristics of these light-emitting elements were measured. It is to be noted that the measurement was performed at room temperature (an atmosphere kept at 25° C.).

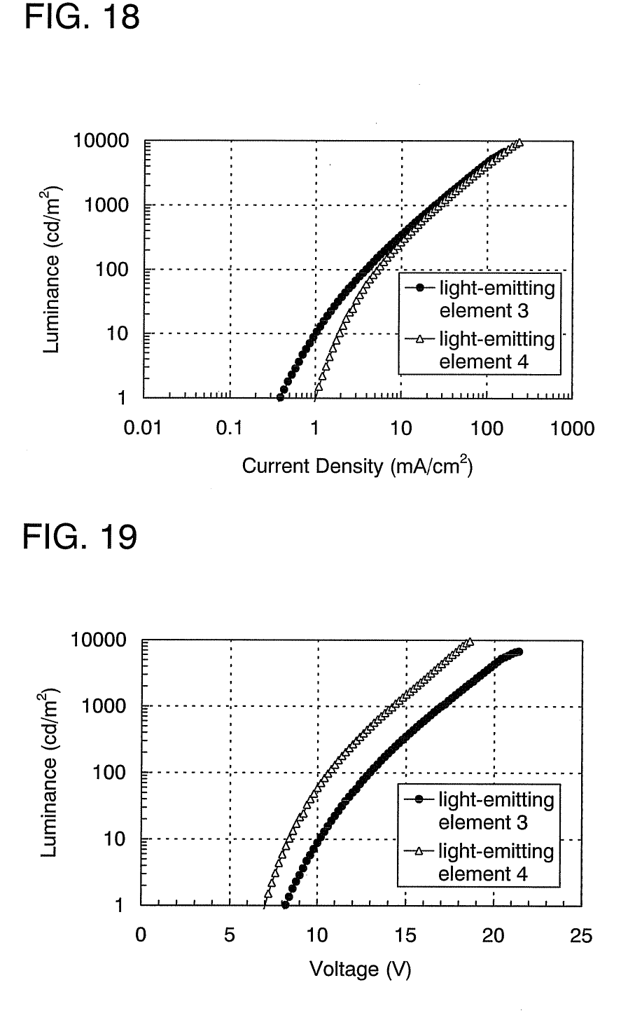

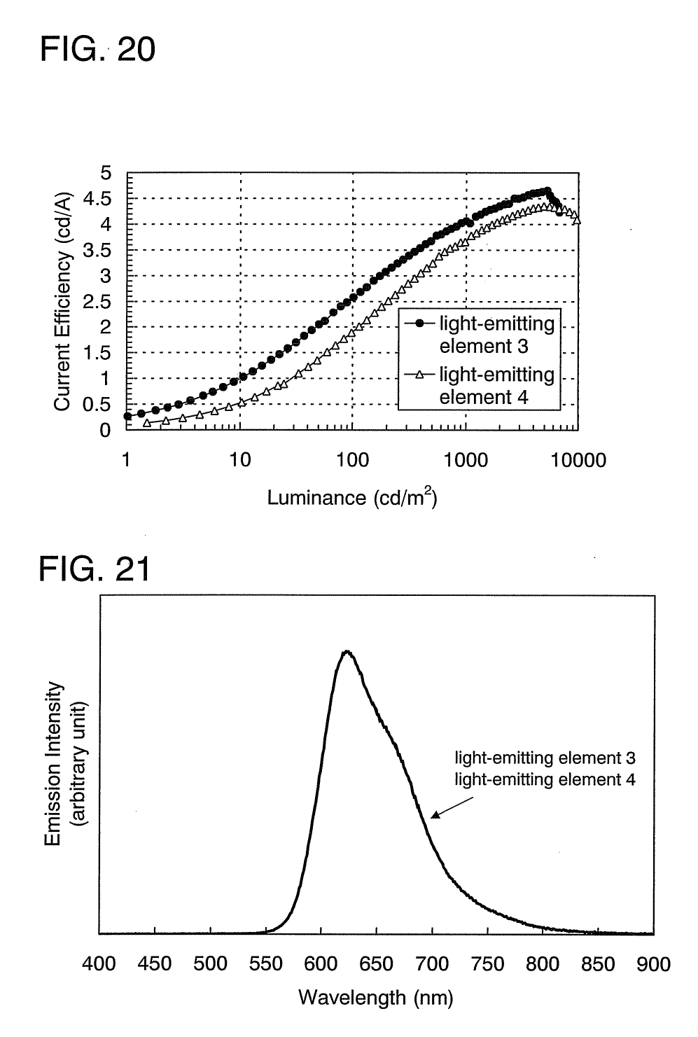

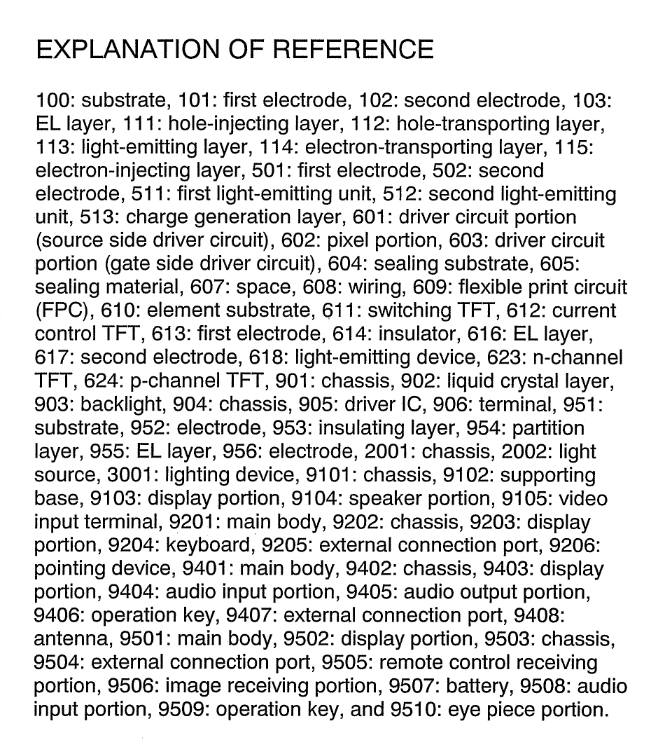

Current density-luminance characteristics, voltage-luminance characteristics, and luminance-current efficiency characteristics of the light-emitting elements 3 and 4 are shown in FIGS. 18, 19, and 20, respectively. Also, the emission spectra measured at current of 1 mA are shown in FIG. 21.

When the luminance of the light-emitting element 3 was 1000 cd/m², the CIE color coordinates were x=0.67 and y=0.33 and the emission color was red, the current efficiency was 4.1 cd/A, which is indicative of high efficiency. The voltage was 17.0 V, the current density was 24.6 mA/cm², and the power efficiency was 0.7 lm/W. The peak wavelength of the emission spectrum was 622 nm as shown in FIG. 21.

When the luminance of the light-emitting element 4 was 980 cd/m², the CIE color coordinates were x=0.67 and y=0.33 and the emission color was red, the current efficiency was 3.7 cd/A, which is indicative of high efficiency. The voltage was 14.2 V, the current density was 26.7 mA/cm², and the power efficiency was 0.8 lm/W. The peak wavelength of the emission spectrum was 622 nm as shown in FIG. 21.

Accordingly, it is found that a light-emitting element with high emission efficiency can be obtained even when a structure of an electron-transporting layer is changed. Therefore, a light-emitting element to which the present invention is applied can have high emission efficiency.

It is also found that a layer can further be formed on a layer including an organic compound by a wet process by use of the composition of the present invention. In particular, a stack of layers by a wet process can be realized in such a manner that a layer that is insoluble in alcohol (an electron-transporting layer in this example) is formed by a wet process and then the composition which uses alcohol of the present invention is applied thereon. Therefore, fabrication using the composition of the present invention is excellent in mass productivity and suitable for industrial application. Furthermore, such fabrication can achieve high material use efficiency and lower fabrication cost.

This application is based on Japanese Patent Application serial no. 2007-077986 filed on Mar. 23, 2007, filed with Japan Patent Office, the entire contents of which are hereby incorporated by reference.

1. An organometallic complex having a structure represented by a general formula (G1), 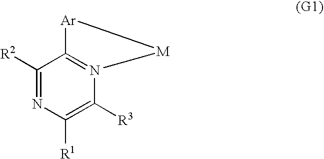
wherein Ar represents an arylene group,
wherein R¹ represents any one of hydrogen, an alkyl group, and an aryl group,
wherein R² represents either an alkyl group or an aryl group,
wherein R³ represents any one of hydrogen, an alkyl group, and an aryl group, and
wherein M is a central metal and represents a Group 9 or Group 10 element.

2. The organometallic complex according to claim 1, wherein Ar is represented by a structural formula (G1)′, and 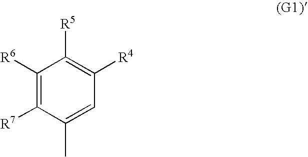
wherein R⁴ to R⁷ each represent any one of an alkyl group, a halogen, and a haloalkyl group.

3. The organometallic complex according to claim 1, wherein M is either iridium or platinum.

4. An organometallic complex having a structure represented by a general formula (G2), 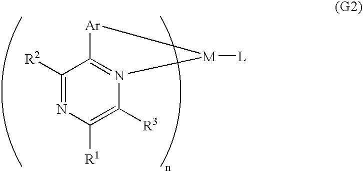
wherein Ar represents an arylene group,
wherein R¹ represents any one of hydrogen, an alkyl group, and an aryl group,
wherein R² represents either an alkyl group or an aryl group,
wherein R³ represents any one of hydrogen, an alkyl group, and an aryl group,
wherein M is a central metal and represents a Group 9 or Group 10 element,
wherein L is a monoanionic ligand, and
wherein n is 2 when M is a Group 9 element and n is 1 when M is a Group 10 element.

5. The organometallic complex according to claim 4, wherein Ar is represented by a structural formula (G1)′, and 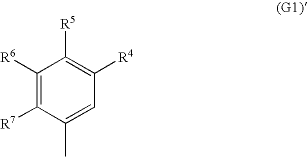
wherein R⁴ to R⁷ each represent any one of an alkyl group, a halogen, and a haloalkyl group.

6. The organometallic complex according to claim 4, wherein L is a monoanionic ligand represented by any one of structural formulae (L1) to (L8) given below.

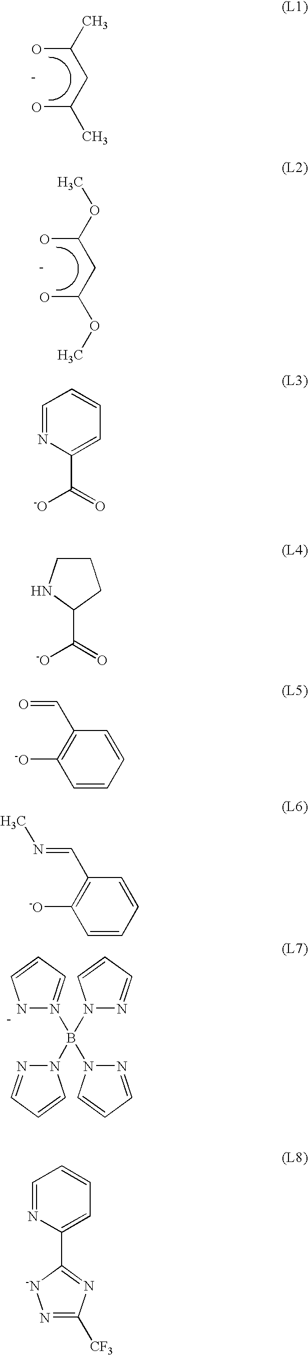

7. The organometallic complex according to claim 4, wherein M is either iridium or platinum.

8. A composition comprising an organometallic complex having a structure represented by a general formula (G1) and a solvent, 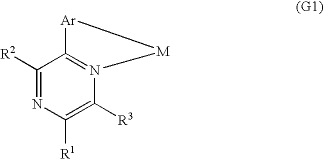
wherein Ar represents an arylene group,
wherein R¹ represents any one of hydrogen, an alkyl group, and an aryl group,
wherein R²represents either an alkyl group or an aryl group,
wherein R³ represents any one of hydrogen, an alkyl group, and an aryl group, and
wherein M is a central metal and represents a Group 9 or Group 10 element.

9. The composition according to claim 8, wherein Ar is represented by a structural formula (G1)′, and 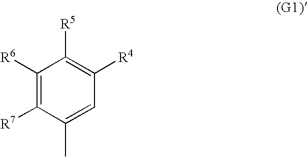
wherein R⁴ to R⁷ each represent any one of an alkyl group, a halogen, and a haloalkyl group.

10. The composition according to claim 8, wherein M is either iridium or platinum.

11. The composition according to claim 8, wherein the organometallic complex is dissolved in the solvent at concentrations of 0.6 g/L or more.

12. The composition according to claim 8, wherein the solvent is an organic solvent not including an aromatic ring.

13. The composition according to claim 8, wherein the solvent is an organic solvent having a boiling point of from 50° C. to 200° C.

14. The composition according to claim 8, wherein the solvent is either ether or alcohol.

15. A composition comprising an organometallic complex represented by a general formula (G2) and a solvent, 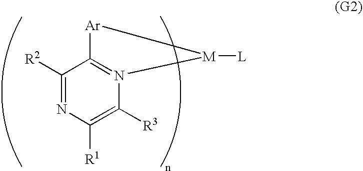
wherein Ar represents an arylene group,
wherein R¹ represents any one of hydrogen, an alkyl group, and an aryl group,
wherein R² represents either an alkyl group or an aryl group,
wherein R³ represents any one of hydrogen, an alkyl group, and an aryl group,
wherein M is a central metal and represents a Group 9 or Group 10 element,
wherein L is a monoanionic ligand, and
wherein n is 2 when M is a Group 9 element and n is 1 when M is a Group 10 element.

16. The composition according to claim 15, wherein Ar is represented by a structural formula (G1)′, and 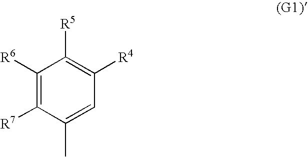
wherein R⁴ to R⁷ each represent any one of an alkyl group, a halogen, and a haloalkyl group.

17. The organometallic complex according to claim 15, wherein L is a monoanionic ligand represented by any one of structural formulae (L1) to (L8) given below.

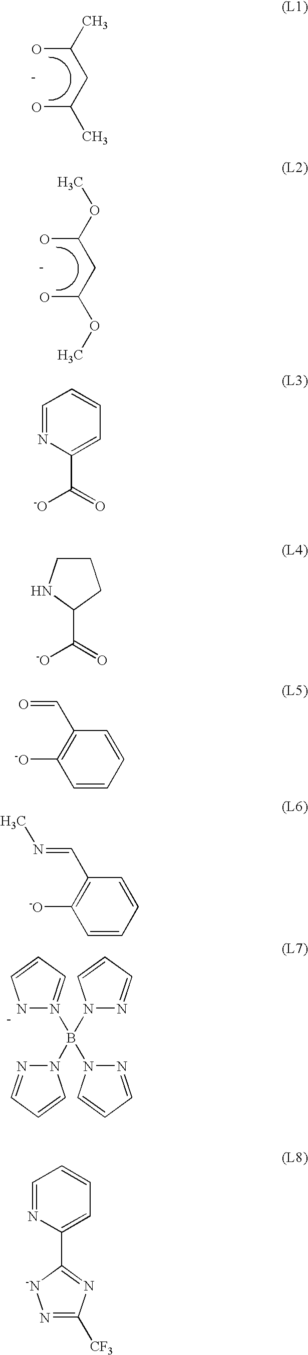

18. The composition according to claim 15, wherein M is either iridium or platinum.

19. The composition according to claim 15, wherein the organometallic complex is dissolved in the solvent at concentrations of 0.6 g/L or more.

20. The composition according to claim 15, wherein the solvent is an organic solvent not including an aromatic ring.

21. The composition according to claim 15, wherein the solvent is an organic solvent having a boiling point of from 50° C. to 200° C.

22. The composition according to claim 15, wherein the solvent is either ether or alcohol.

23. A light-emitting device comprising:
a light-emitting element comprising, between a pair of electrodes, a layer including an organometallic complex having a structure represented by a general formula (G1) and a high molecular compound, 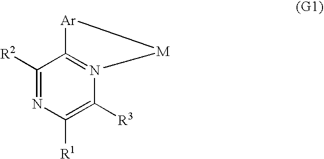
wherein Ar represents an arylene group,
wherein R¹ represents any one of hydrogen, an alkyl group, and an aryl group,
wherein R² represents either an alkyl group or an aryl group, and
wherein M is a central metal and represents a Group 9 or Group 10 element.

24. The light-emitting device according to claim 23, wherein Ar is represented by a structural formula (G1)′, and 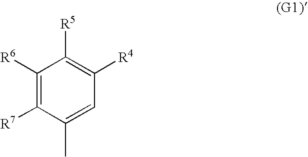
wherein R⁴ to R⁷ each represent any one of an alkyl group, a halogen, and a haloalkyl group.

25. The light-emitting device according to claim 23, wherein M is either iridium or platinum.

26. The light-emitting device according to claim 23, wherein the layer including the organometallic complex and the high molecular compound is a light-emitting layer.

27. A method for fabricating a light-emitting element comprising:
forming a first electrode;
forming a layer including an organic compound by an evaporation method over the first electrode;
applying the composition comprising an organometallic complex having a structure represented by a general formula (G1) and a solvent over the layer;
removing the solvent; and
forming a second electrode, 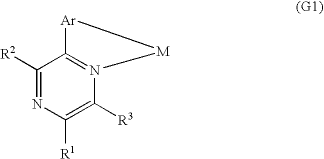
wherein Ar represents an arylene group,
wherein R¹ represents any one of hydrogen, an alkyl group, and an aryl group,
wherein R² represents either an alkyl group or an aryl group, and
wherein M is a central metal and represents a Group 9 or Group 10 element.

28. The method for fabricating a light-emitting element according to claim 27, wherein Ar is represented by a structural formula (G1)′, and 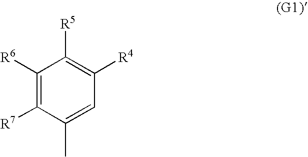
wherein R⁴ to R⁷ each represent any one of an alkyl group, a halogen, and a haloalkyl group.

29. The method for fabricating a light-emitting element according to claim 27, wherein M is either iridium or platinum.
